(19) United States
(12) Patent Application Publication
(10) Pub. No.: US 2003/0030862 A1
(43) Pub. Date: Feb. 13, 2003

(54) Device and method for monitoring signal characteristics of optical signals in an optical communications network

(76) Inventors: Joseph Trier, Henniker, NH (US); Kevin Short, Windham, NH (US); Michael Sussman, Winchester, MA (US)

Correspondence Address: JENKENS & GILCHRIST, P.C., 3200 Fountain Place, 1445 Ross Avenue, Dallas, TX, 75202-2799, US

(21) Appl. No.: 10/162,409

(22) Filed: Jun. 3, 2002

Related U.S. Application Data
(60) Provisional application No. 60/295,254, filed on Jun. 1, 2001.

(51) Int. Cl. H04B 10/08; H04B 10/02

(52) U.S. Cl. 359/110; 359/177

(57) ABSTRACT

A device and method of monitoring wavelength division multiplexed signals are disclosed. The device includes a user interface for defining channels of the wavelength division multiplexed signals to be measured, and graphically viewing measured signal characteristics of the wavelength division multiplexed signals. The user interface further allows for defining of alarm levels for signal characteristics to be measured, and indicating when a measured signal characteristic falls outside of the defined alarm levels.

### BACKGROUND OF THE INVENTION

1. Technical Field of the Invention

The present invention relates to monitoring activity within an optical communications network, and particularly to a device and method for sensing various signal characteristics of optical signals transported within the optical communications network.

2. Description of the Related Art

The telecommunications industry has grown significantly in recent years due to developments in technology, including the Internet, e-mail, cellular telephones, and fax machines. These technologies have become affordable to the average consumer such that the volume of traffic on telecommunications networks has grown significantly. Furthermore, as the Internet has evolved, more sophisticated applications have increased the volume of data being communicated across the telecommunications networks.

To accommodate the increased data volume, the infrastructure of the telecommunications networks has been evolving to increase the bandwidth of the telecommunications networks. Fiber optic networks that carry wavelength division multiplexed optical signals provide for significantly increased data channels for handling the high volume of traffic. One component of the fiber optic network is an optical performance monitor (OPM), which is a spectrometer capable of measuring power and wavelength across a spectrum formed from the wavelength division optical signals. By measuring this signal characteristic, the OPM may be utilized to monitor the health of the telecommunications network.

One type of OPM is a focal plane array-based OPM. A typical focal plane array based OPM includes optical components that separate the wavelength division multiplexed optical signals into its constituent monochromatic or narrowband optical signals. The optical components of the focal plane array based OPM generally include lenses for focusing and collimating the optical signals, a diffraction grating for separating the wavelength division multiplexed optical signals to form a spatial representation of its discrete power spectrum, and a photo-diode array or other optical detector that converts the discrete power spectrum into electrical signals for subsequent analysis.

As optical communications networks have become more sophisticated and more heavily used, the demand for more closely monitoring activity within the optical communications network has increased to ensure messages communicated within the optical communications network are successfully received. Because some existing OPM devices may fail to provide a sufficient amount of information to accurately and reliably monitor all of the ever increasing activities occurring within an optical communications network, there is a need for an OPM device having enhanced network-monitoring capabilities.

### SUMMARY OF THE INVENTION

Embodiments of the present invention overcome shortcomings in prior optical communications networks and satisfy a significant need for a monitor device that monitors a variety of operating characteristics of the optical communications network. The monitor device includes a processing unit, such as a general purpose processor or digital signal processor, and software for measuring and/or recording a number of characteristics of optical signals transported along one or more fiber optic lines within the optical communications network.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1 is a block diagram of an optical communications network including an optical monitor device according to exemplary embodiments of the present invention;

FIG. 2 is a diagram of the optical monitor device according to an exemplary embodiment of the present invention;

FIGS. 3-5 are diagrams illustrating alarm window settings for wavelength, power and OSNR, respectively, according to an exemplary embodiment of the present invention;

FIG. 6 is a display provided by the optical monitor device of FIG. 2;

FIG. 7 is a menu display provided by the optical monitor device of FIG. 2;

FIG. 8 is a display of a measured optical power spectrum provided by the optical monitor device of FIG. 2;

FIG. 9 is a display of measured channel power levels provided by the optical monitor device of FIG. 2;

FIG. 10 is a display of measured channel power levels provided by the optical monitor device of FIG. 2;

FIG. 11 is a display of measured signal characteristics of a channel provided by the optical monitor device of FIG. 2;

FIG. 12 is a display of measured signal characteristics of a channel provided by the optical monitor device of FIG. 2;

FIG. 13 is a display of measurements of an optical power spectrum provided by the optical monitor device of FIG. 2;

FIG. 14 is a display of measured signal characteristics of an optical power spectrum provided by the optical monitor device of FIG. 2;

FIG. 15 is a display of multiple channel measurements provided by the optical monitor device of FIG. 2;

FIG. 16 is a display of measured power levels and an average power level provided by the optical monitor device of FIG. 2;

FIG. 17 is a display of alarm conditions provided by the optical monitor device of FIG. 2;

FIG. 18 is a display of recorded events provided by the optical monitor device of FIG. 2; and

FIG. 19 is a displayed window, provided by the optical monitor device of FIG. 2, for defining channels of an optical signal to be measured.

### DETAILED DESCRIPTION OF THE PREFERRED EXEMPLARY EMBODIMENTS

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough and complete, and will fully convey the scope of the invention to those skilled in the art.

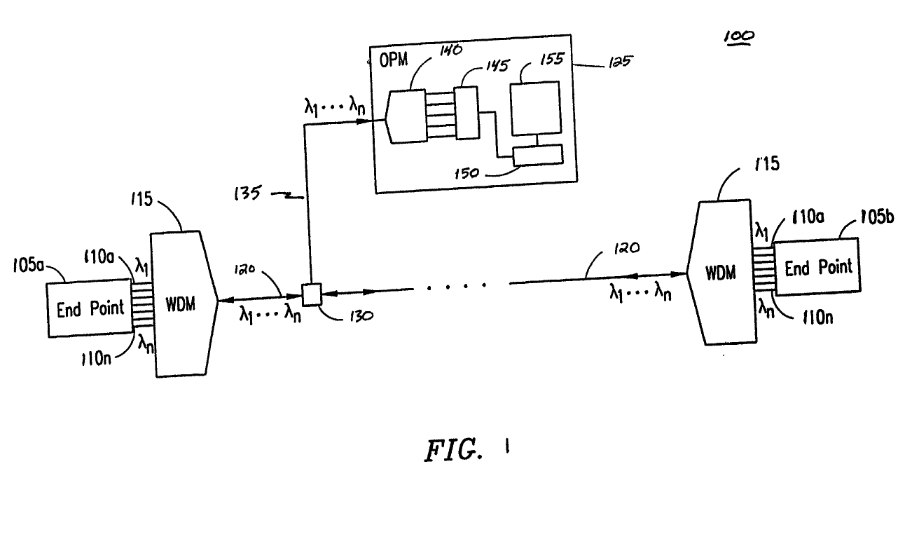

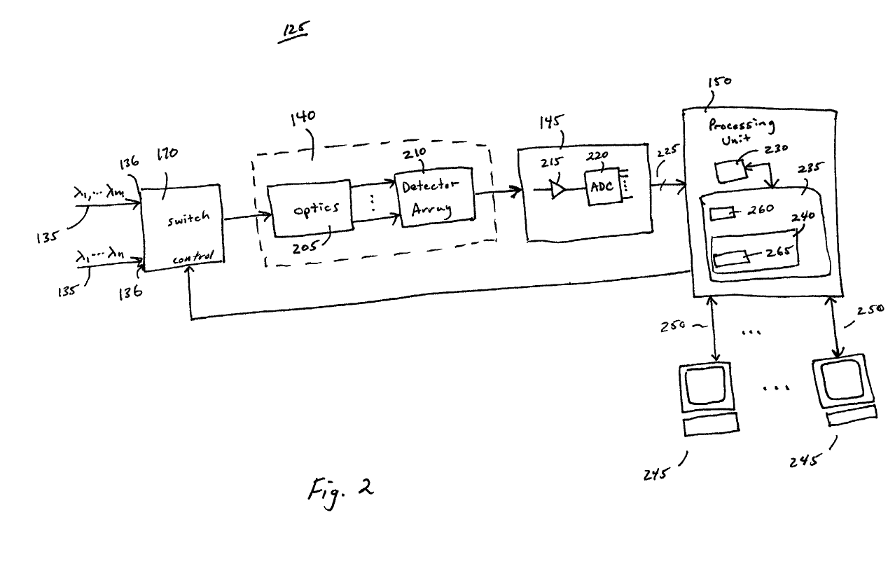

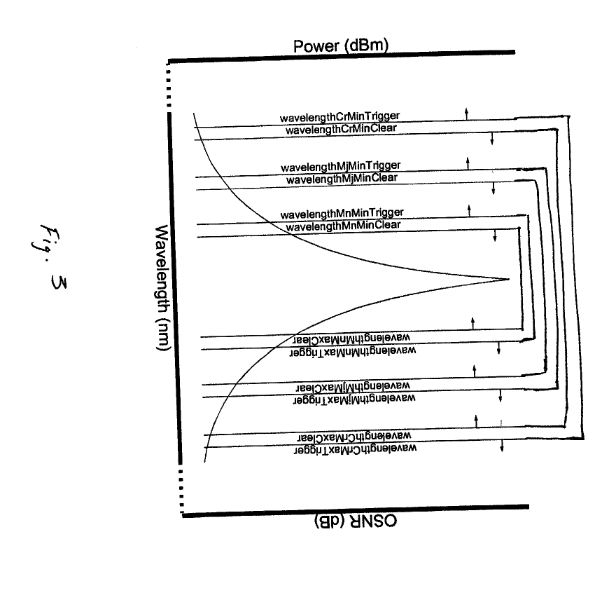

Referring to FIGS. 1-2 there is shown an optical performance monitor 125 for monitoring signal characteristics of optical signals transported over a fiber optic line in an optical communications network 100.

FIG. 1 illustrates an exemplary optical communications network 100 in which optical performance monitor 125 may be disposed. Optical communications network 100 may include optical components commonly found in optical communications networks. For instance, the exemplary optical network 100 may include two end points 105a and 105b. The two end points may possibly represent two different cities that are in fiber optic communication with each other. At each city, a network operator may maintain fiber optic network equipment. At each end point 105a and 105b, a plurality of fiber optic lines 110a, 110b, . . . , 110n, are capable of carrying narrowband optical signals having center wavelengths λ₁, λ₂, . . . , λₙ (i.e., λ₁-λₙ). The narrowband optical signals may, for example, have center wavelengths λ₁-λₙ within the range of at least the optical C-band (approximately 1527 nm to approximately 1566 nm) and/or L-band (approximately 1560 nm to approximately 1610 nm). Each narrowband optical signal in optical communications network 100 may be a time division multiplexed signal and may be wavelength division multiplexed with the other narrowband optical signals by a wavelength division multiplexer/demultiplexer 115.

An optical performance monitor 125 may be coupled to a fiber optic line 120 in the optical communications network 100 so as to monitor signal characteristics, such as energy/power levels, center wavelength, and optical signal-to-noise-ratio of optical signals transported within optical communications network 100. In this way, optical performance monitor 125 may be used to monitor ensure proper operation of equipment in optical communications network 100.

Optical performance monitor 125 measures the narrowband optical signals λ₁-λₙ via an optical splitter 130 by extracting and routing a percentage of the power of the multiplexed optical signal to an input fiber optic line 135. The optical performance monitor 125 receives the multiplexed optical signal from the input fiber optic line 135.

The optical performance monitor 125 may include a pixelated optical detector based spectrometer 140, electronics 145, processing unit 150, and a device 155 for communicating or displaying measurements. The spectrometer 140 spatially disperses the multiplexed optical signal onto a pixelated or array of optical detector elements within spectrometer 140. The pixelated optical detector may be indium gallium arsenide (InGaAs). Other materials for the pixelated optical detector array may be utilized. It should be understood that the principles of the present invention are not dependent upon the particular optical components of the optical performance monitor 125.

The optical detector array converts the narrowband optical signals into electrical signals in parallel. The electronics 145 prepare the measurements for a processing unit 150. The processing unit 150 includes a processor, such as a general processor or a digital signal processor (DSP), that performs the deconvolution operation, optical signal-to-noise computations, and other monitoring calculations.

The device 155 included as part of the OPM 125 may either be a communication device (e.g., modem, line driver, optical driver, transmitter) or a display device (e.g., monitor) to communicate or display, respectively, the results of the calculations performed by the processing unit 150. If the device 155 communicates the results, such communication may be via a network, such as the Internet, the optical network 100, a local area network, or cable connected directly to a display device.

FIG. 2 is a more detailed block diagram of the optical performance monitor 125, showing the spectrometer 140, electronics 145, and processing unit 150. OPM 125 may include more than one fiber optic input port 136 so that OPM 125 may be coupled to a plurality of fiber optic lines 135 and therefore be capable of monitoring signal characteristics of signals appearing on multiple fiber optic lines 135. In this exemplary embodiment, each fiber optic line 135 is coupled to spectrometer 140 via an optical switch 170. Optical switch 170 may be manipulated to selectively optically couple either fiber optic line 135 to spectrometer 140. Optical switch 170 may be controlled by processing unit 150.

The spectrometer 140 may include optics 205 and a pixelated optical detector array 210. The optics 205 includes an input port coupled to the output of optical switch 170. The optics 205 may include a diffraction grating (not shown) to disperse the wavelength division multiplexed optical signal received from either input fiber optic line 135. Other optical components may also be included in the optics 205 to image the narrowband optical signals λ₁-λₙ onto the pixelated optical detector array 210. The pixelated optical detector array 210 may be comprised of a plurality of substantially independent detector elements or pixels, where the individual pixels convert, in parallel, a component of the imaged discrete power spectrum of the wavelength division multiplexed signal into electrical signals.

The electronics 145 are electrically coupled between the pixelated optical detector array 210 and the processing unit 150. The electronics 145 may include conditioning circuits (e.g., linear amplifiers) 215 and analog-to-digital (A/D) converters 220 to convert the pixelated optical detector array 210 output to a digital signal. The output of the electronics 145 may include one or more serial or parallel buses 225 connected to the processing unit 150.

The processing unit 150 may include a processor 230 and a memory 235 coupled thereto. The processor 230 may execute a software program 240 and/or software routines 260 in order to process the data received from the electronics 145. The data and the software program 240 may be stored in the memory 235 and be utilized during operation of the OPM 125. The processing unit 150 may be coupled to one or more computing devices 245, such as personal computers or workstations, for visually presenting the processed data to a user/operator using software program 240 and/or software routines 260. OPM 125 may include a CRAFT (RS-232) interface for supporting the transfer of data and software with a serial terminal, and an Ethernet interface for supporting the transfer of data and software with devices on an Ethernet local area network (LAN). The OPM 125 may include an interface for FTP, Telnet, TL1 and SNMP communication.

Spectrometer 140 provides to processor 230 data representative of power, wavelength and OSNR values of the wavelength division multiplexed optical signal measured. The processor 230 executes the software program 240 to process the data for presentation to a user. For example, processor 230 may detect alarm and event conditions, update alarm/event logs and generate signals for displaying the power, wavelength and OSNR measurements on devices 245 in graphic and tabular forms. The generated signals may thereafter be communicated via the bus 250 to a computing device 245 for presentation of power versus wavelength and/or pixel, for example, to the operator of the optical network. Although not shown in detail, it should be understood that the processing unit 150 includes additional circuitry, such as receivers and transmitters (e.g., line drivers), memory, and other typical processing hardware and software for performing the signal processing operations.

Through use of software program 240/software routines 260, OPM 125 may be configured for measuring and determining various signal characteristics of WDM signals received by OPM 125. For instance, OPM 125 may be configured to define a channel map for each wavelength division multiplexed optical signal coupled to a port 136 coupled to the inputs of OPM 125. A channel map includes channel definitions for channels in wavelength division multiplexed signals to be monitored. Channel definitions for a channel may be used by OPM 125 to monitor the channel. The channel definitions for a channel may include the channel number, a description of the channel, minimum, center and maximum wavelengths, and a channel ID.

In addition, the channel definitions for a channel may include various alarm settings associated with signal characteristics of the channel. The alarms for a channel may include alarms for monitoring center wavelength, power levels and OSNR of the channel. The alarms may be used to detect when a signal characteristic of a channel falls outside a desired window of values. For a given signal characteristic (wavelength, power, OSNR, for example), one or more alarm-related windows of values may be defined. For example, a minor alarm window may define a window or range of values for a signal characteristic which may affect service when the value of the signal characteristic falls outside the window. A major alarm window may define a larger window/range of values for the signal characteristic, outside of which a danger of lost service exists. A critical alarm window may define an even larger window/range of values for the signal characteristic, outside of which service is lost. The alarms may be defined and graphically displayed on devices 245, as explained in greater detail below.

Additional alarms may include the detection of zero signal peaks or two signal peaks in a channel. In the event no signal peaks or two signal peaks are detected within a defined wavelength range, an alarm may be set.

Defined alarm windows may include a hysteresis effect to prevent an undesirably large number of alarm events from being generated due to a signal characteristic being similar in value to the value of an alarm setting. Specifically, OPM 125 may include, for each signal characteristic, “trigger” and “clear” alarm windows. The clear alarm windows are relatively slightly smaller than their corresponding trigger alarm windows. During use, in the event a signal characteristic falls outside of the trigger alarm window defined for the signal characteristic, the alarm is activated and remains activated until the signal characteristic returns to being within the corresponding clear alarm window. The alarm will not be activated thereafter unless the signal characteristic falls outside the trigger alarm window a second time. By use of trigger and clear alarm windows, only a single alarm is activated in response to the signal characteristic falling outside of the trigger alarm window. FIG. 3 graphically illustrates the trigger and clear alarm window configurations for the minor, major and critical alarm windows for the wavelength measurement of a channel. FIG. 4 graphically illustrates the trigger and clear alarm window configurations for the minor, major and critical alarm windows for the power measurement of a channel. FIG. 5 graphically illustrates the trigger and clear alarm window configurations for the minor, major and critical alarm windows for the OSNR measurement of a channel.

Upon the alarms for a signal characteristic of a channel being defined, OPM 125 determines whether the defined alarm values are valid, relative to each other.

OPM 125 may define default alarm settings for an input signal, based upon the corresponding channel definitions. Alarms for a channel may be disabled by default by OPM 125.

In order to provide additional flexibility in monitoring signals generated from a number of different sources, OPM 125 may allow channel and alarm definitions to be assigned to a device/source. In this way, OPM 125 may maintain in nonvolatile memory (forming a part of memory 235, for example) channel and alarm definitions for a device, while other devices/sources, having other channel and alarm definitions assigned thereto, are coupled to the input of OPM 125. The stored definitions for a device may be retrieved from memory when it is desired to monitor the device.

The OPM 125 may additionally maintain a record of events that occur during the operation of OPM 125. Events may be defined as the occurrence of any of a number of activities in spectrometer 140 or processing unit 150. For example, events may include alarms being triggered or cleared, configurations being saved, multiple unsuccessful login attempts, etc. Upon the occurrence of an event, OPM 125 maintains a record of the event in memory 235. The record may include, among other things, the type of event, the record number, the input signal and channel number, and the time of the event. The contents of a record may be viewed on a device 245, as explained in greater detail below.

The OPM 125 may provide for a number of levels for accessing OPM 125. For instance, OPM 125, and particularly the software program 240 therein, may provide for four levels of access. A first access level may be an administrator access in which all functions including configuration functions may be accessed. An administrator access user may install/upgrade software program 240; add/delete user accounts; modify passwords for user accounts; and configure devices, channels and alarms.

A second access level may be a configuration access in which all functions including configuration functions may be accessed. A configuration access user may view and modify device, channel, alarm and event information, and configure devices, channels, alarms, etc.

A third access level may be an operator access in which the OPM 125 may be manipulated but the configuration may not be modified. An operator access user may view device, channel, alarm and event information; view software and spectrometer data; and select a device to be measured.

A fourth access level may be a guest access which allows read-only access to data files and access to various views, displays and a limited number of commands.

OPM 125 may include a graphical user interface (GUI) 265 forming part of software program 240 that allows for controlling and monitoring OPM 125. The GUI 265 may provide a user-friendly, point-and-click graphical interface.

The GUI 265 may provide, on a device 245, a number of pull-down menus for accessing/executing various commands of GUI 265. FIG. 6 shows a display appearing on a display device 245 in which a number of pull-down menus 400 and a toolbar 401are presented for access by a user. A “file” menu 400A may provide commands to allow a user to generate a report of various views of channels of the WDM signals appearing on fiber optic lines 135; display properties of the OPM 125; display user account information; and connect to and disconnect from the OPM 125.

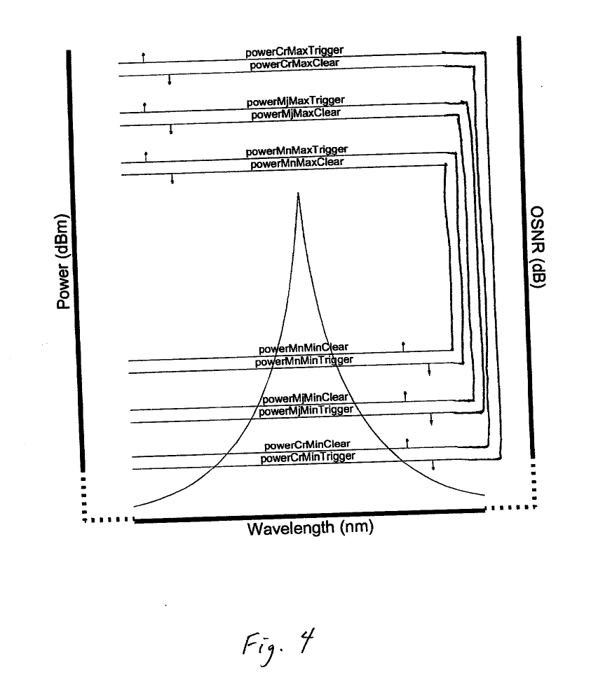

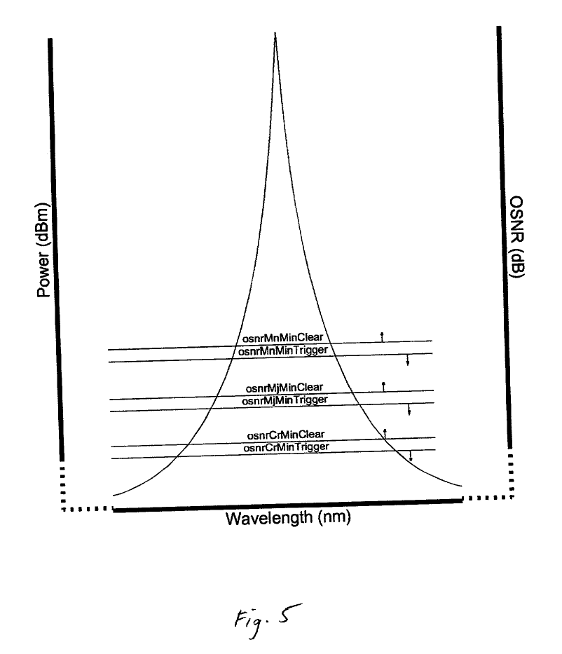

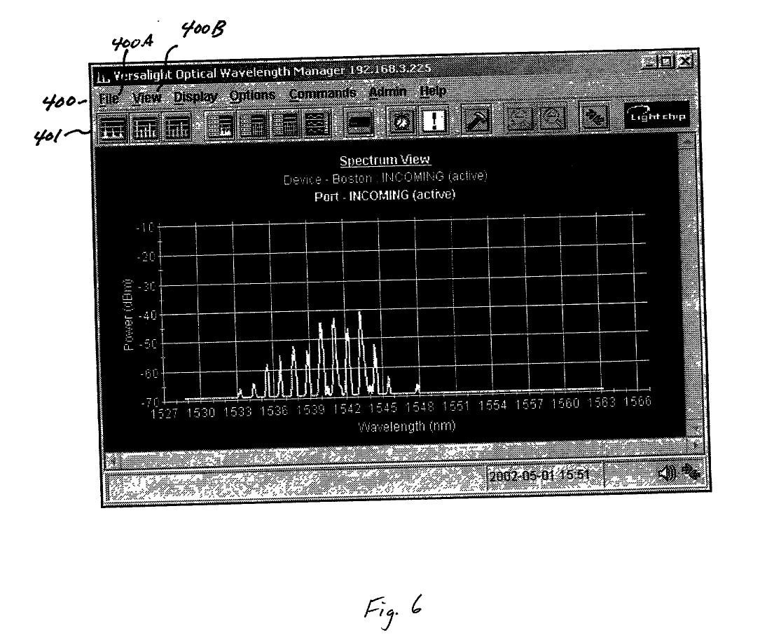

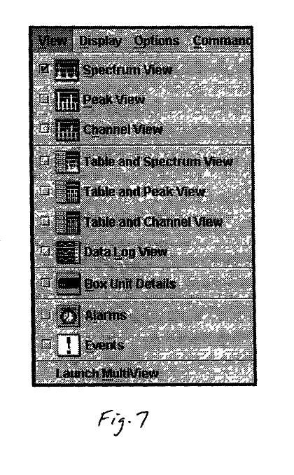

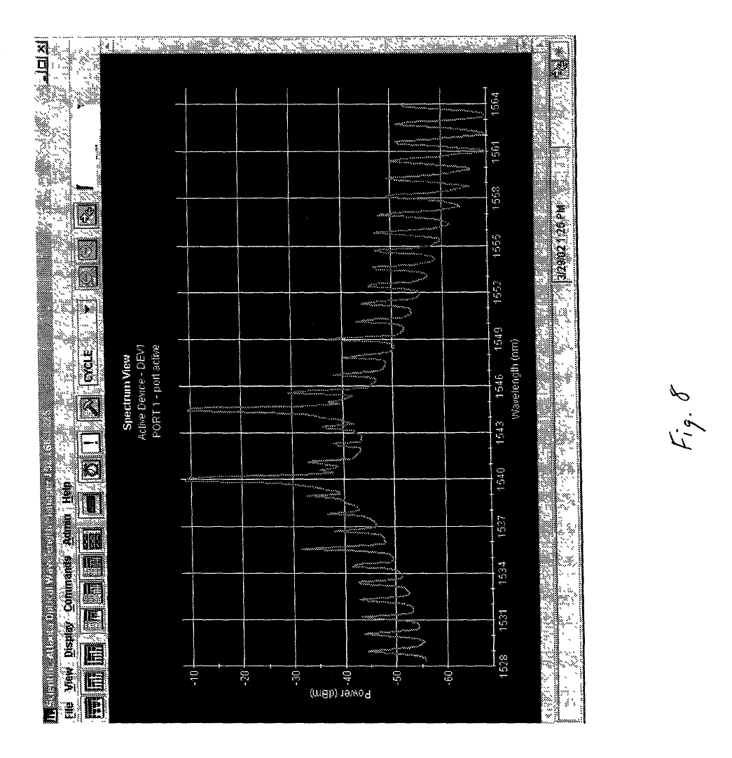

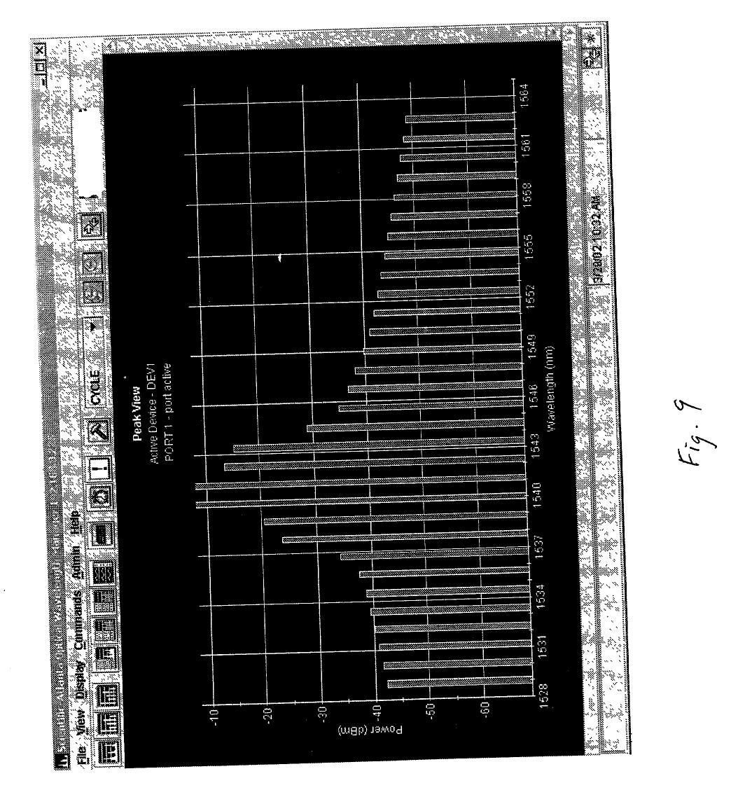

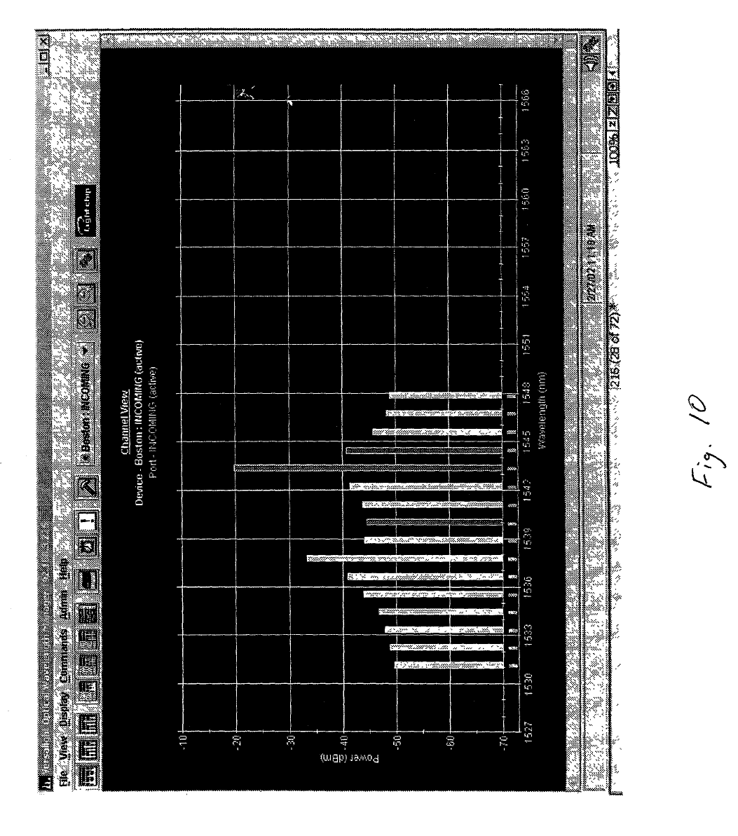

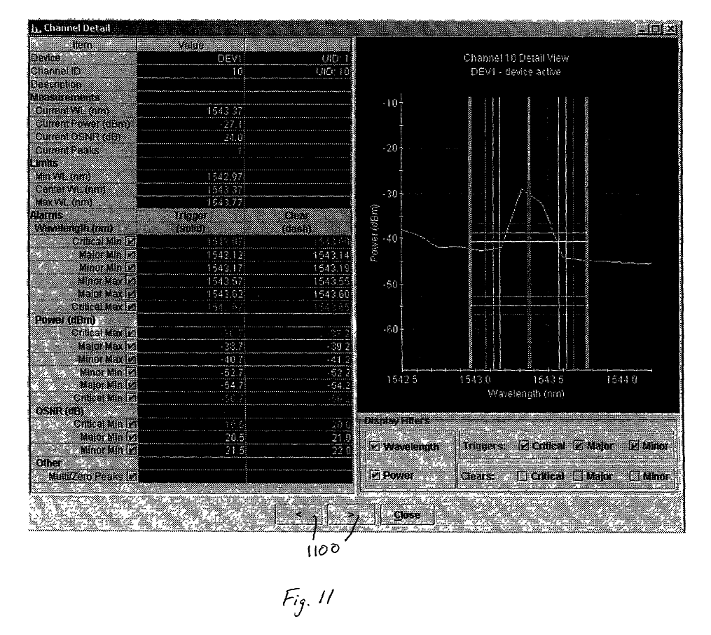

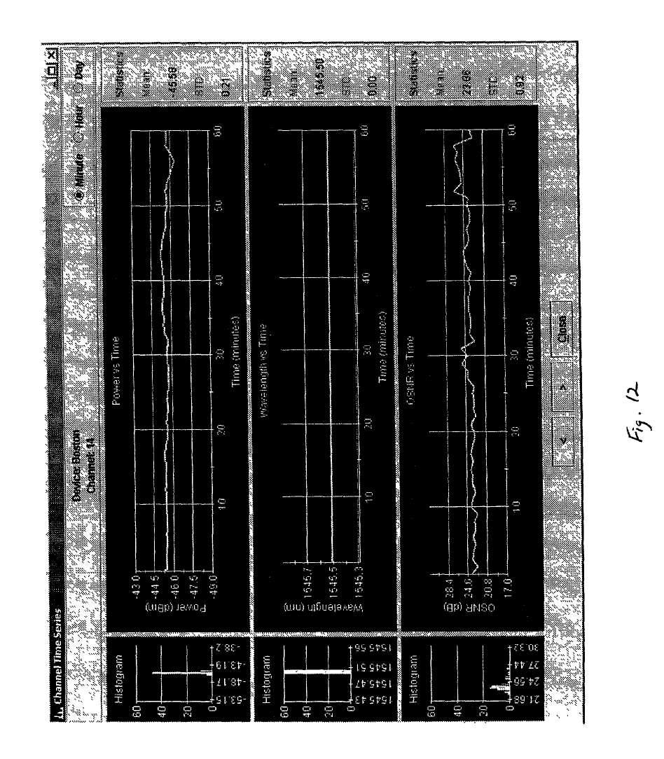

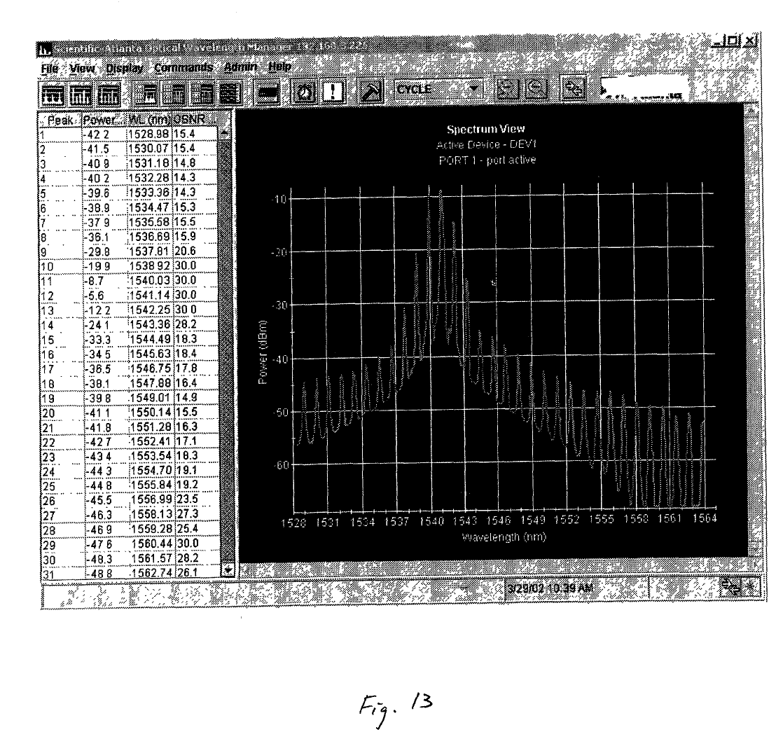

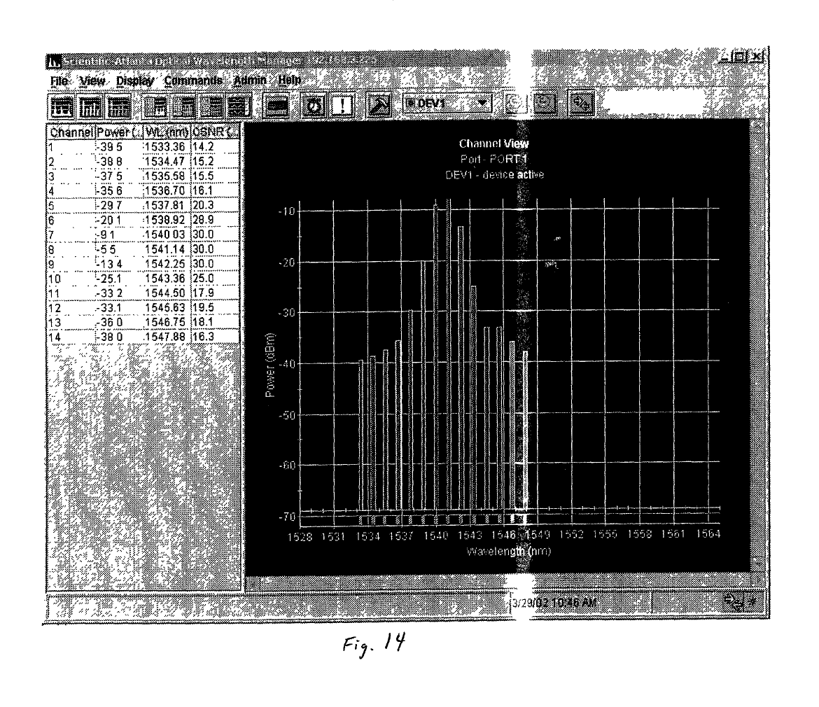

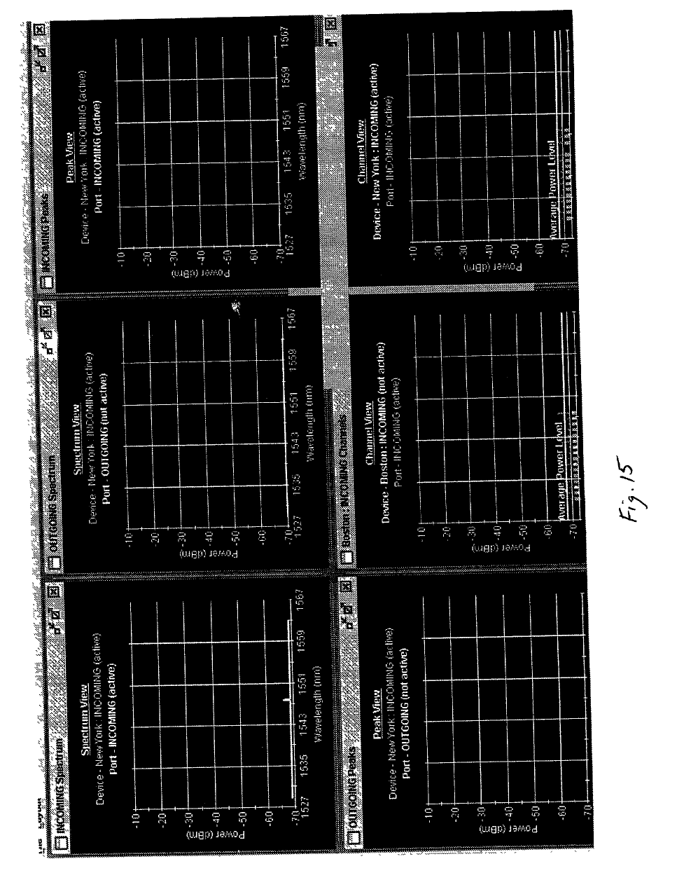

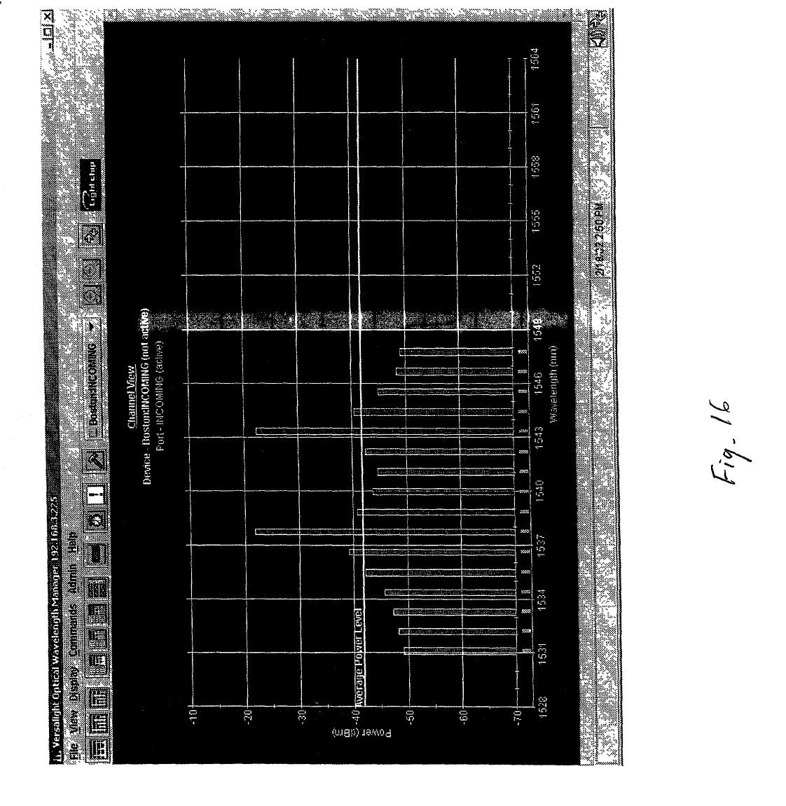

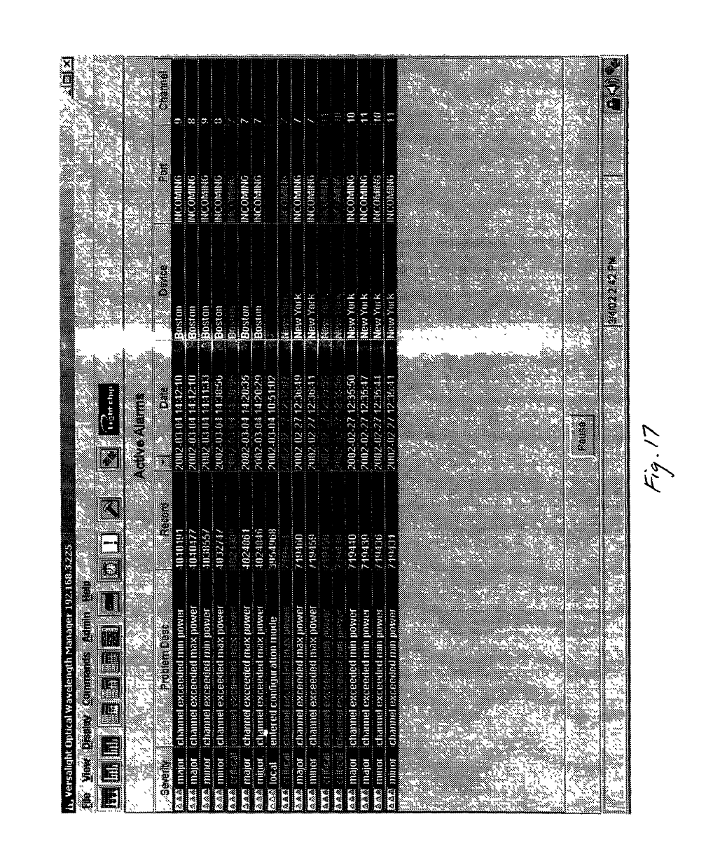

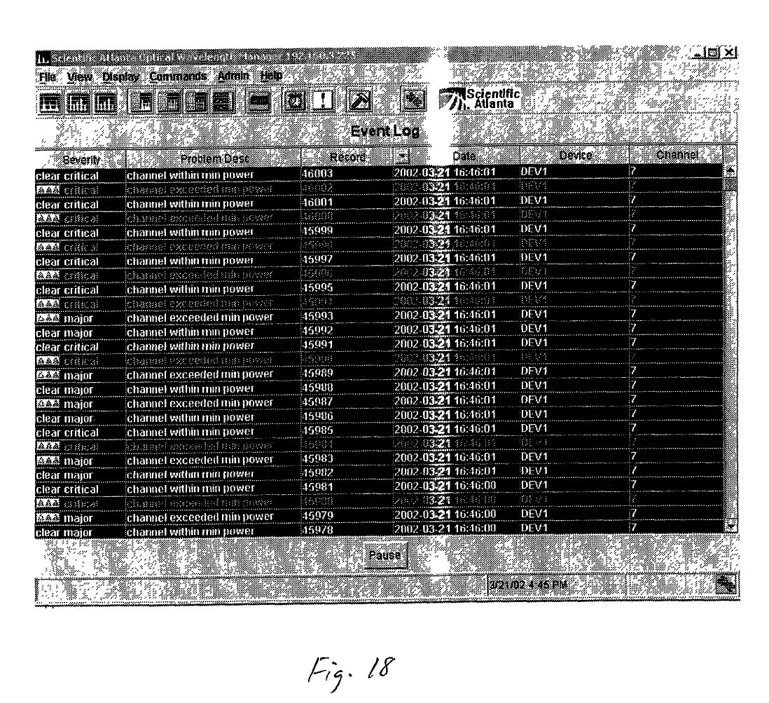

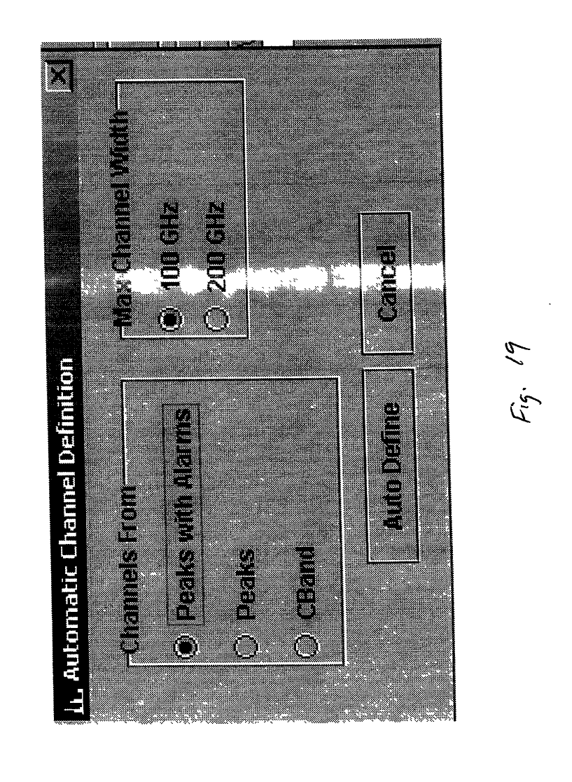

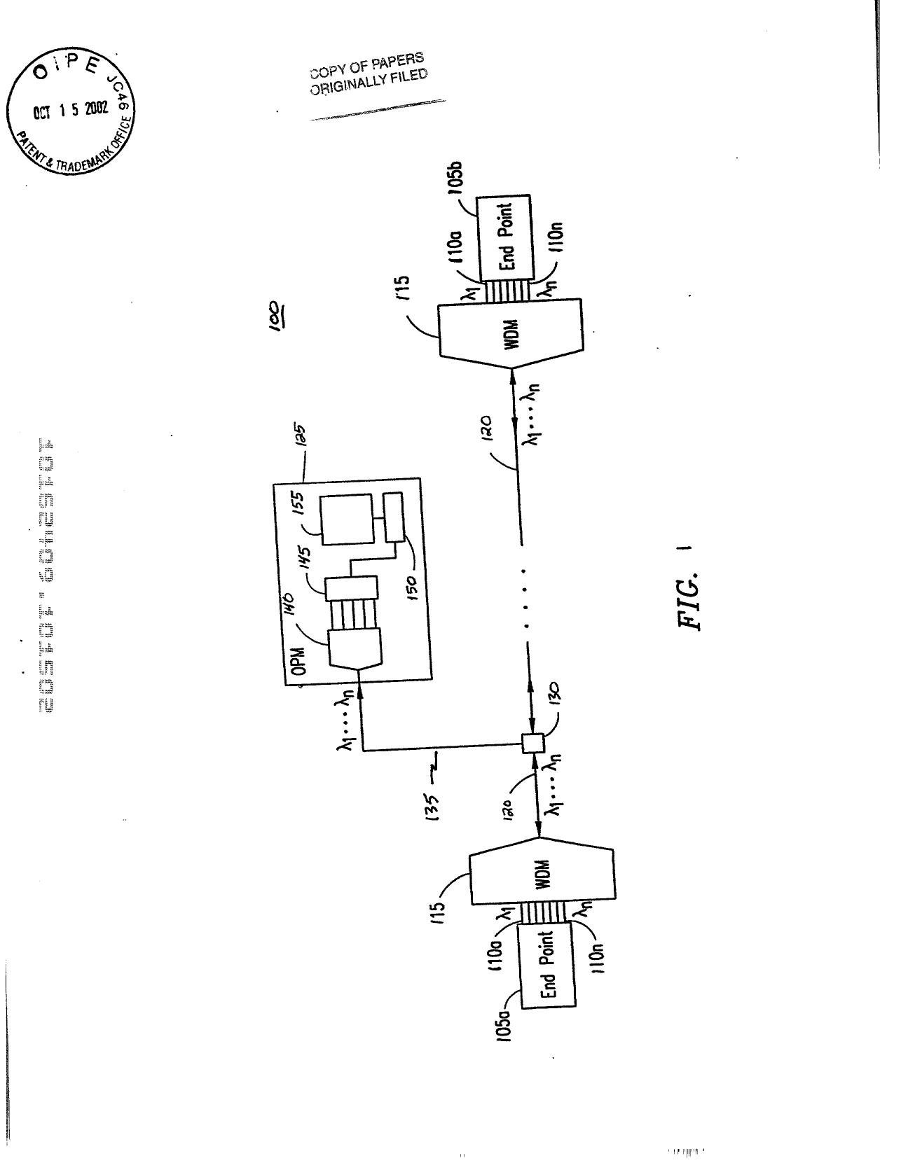

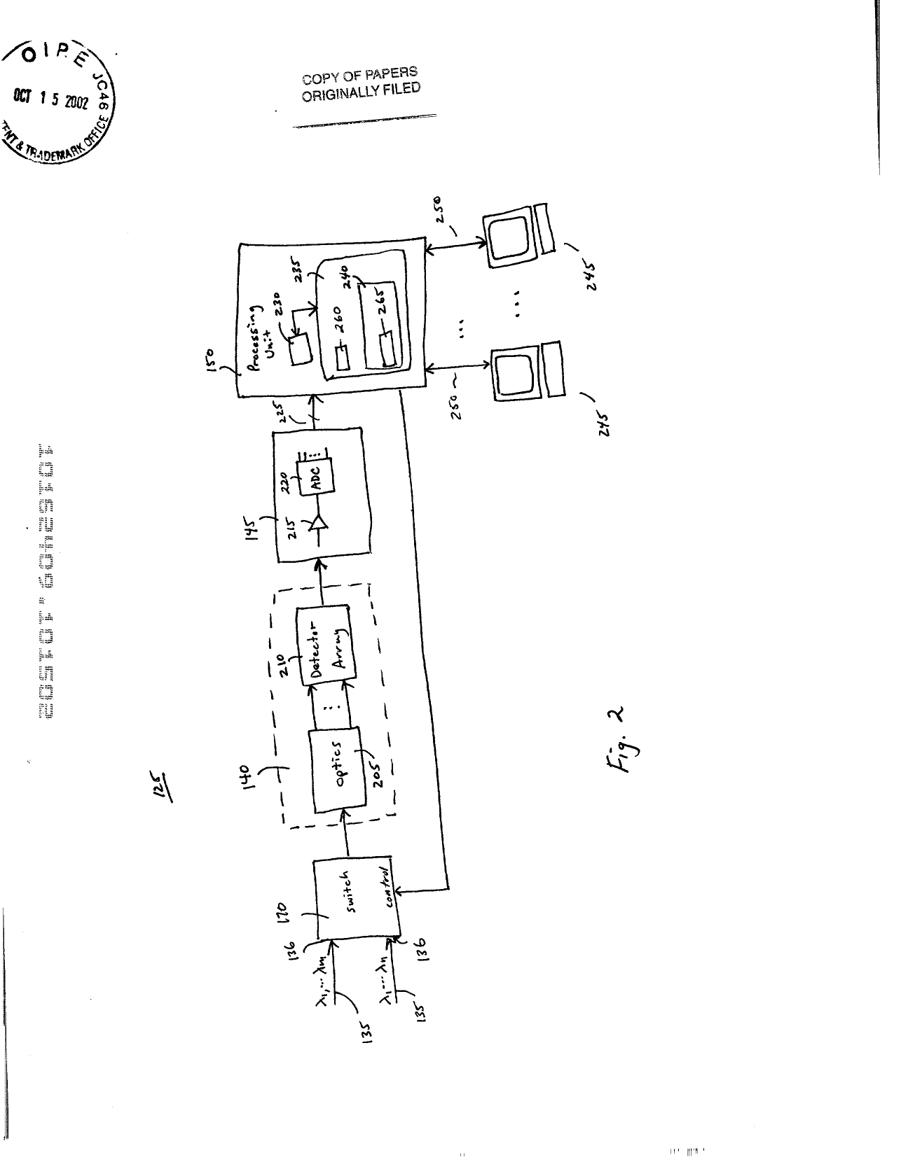

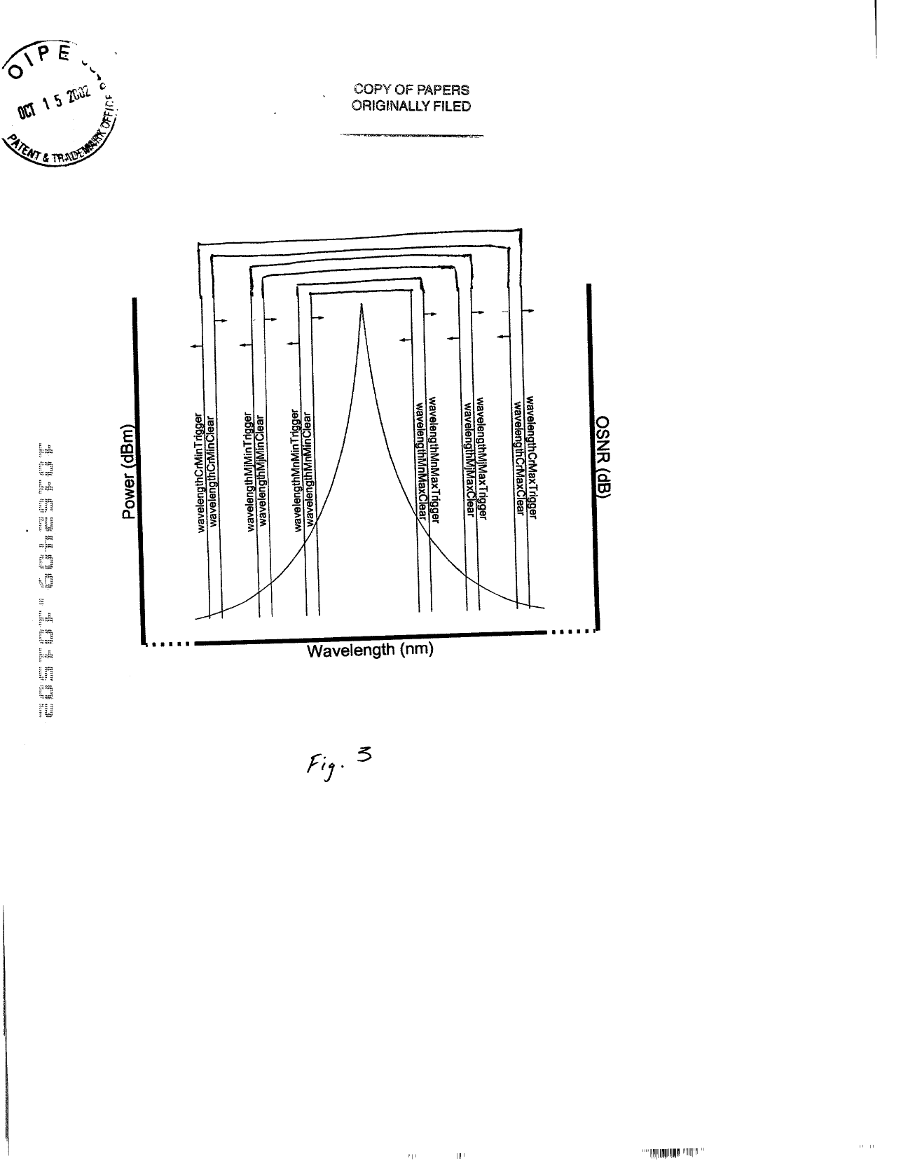

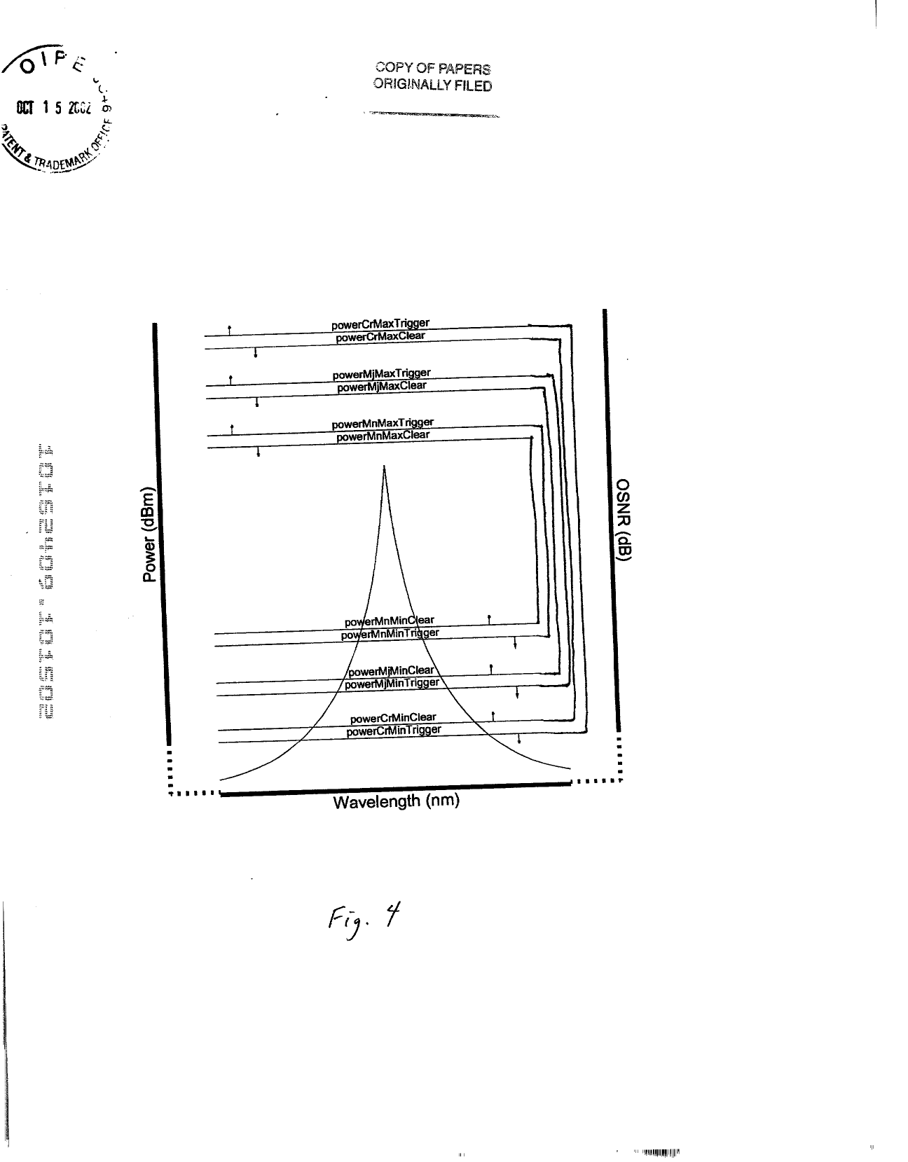

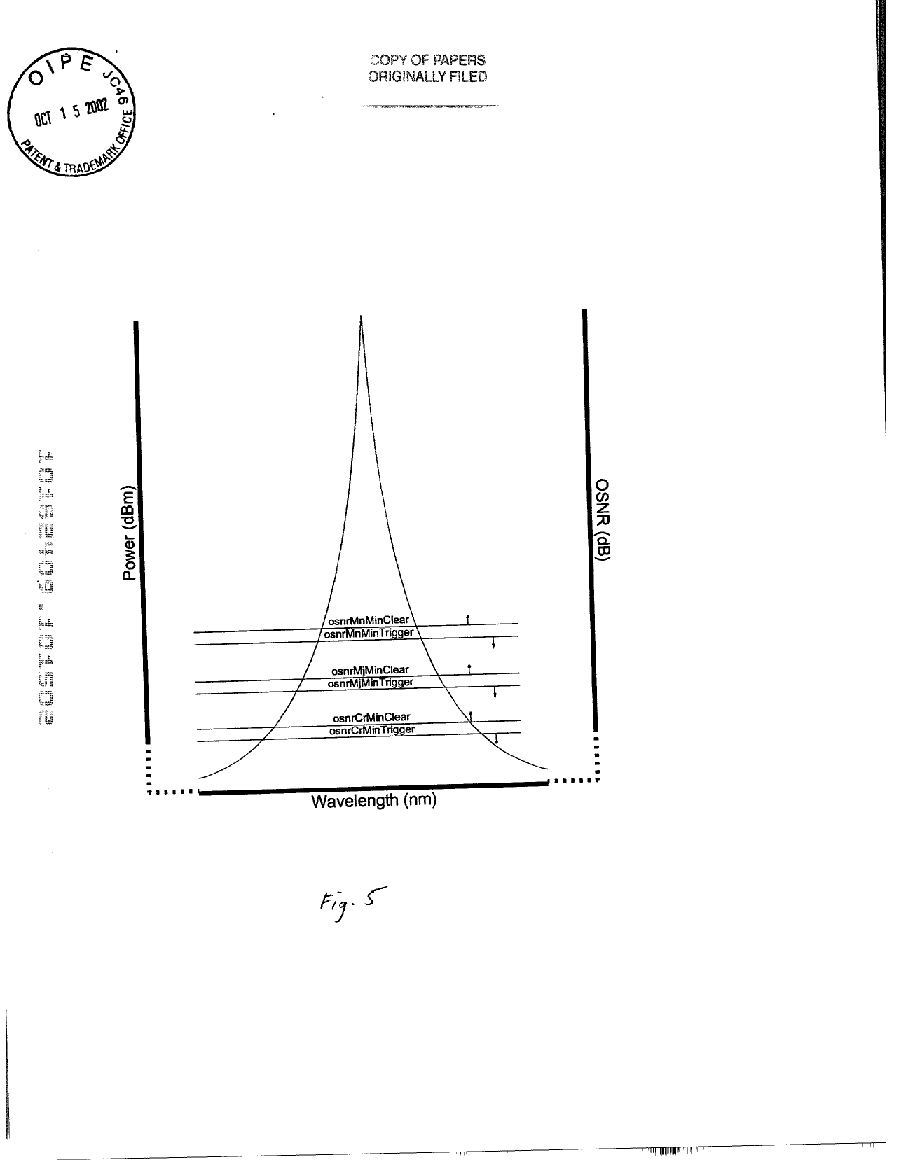

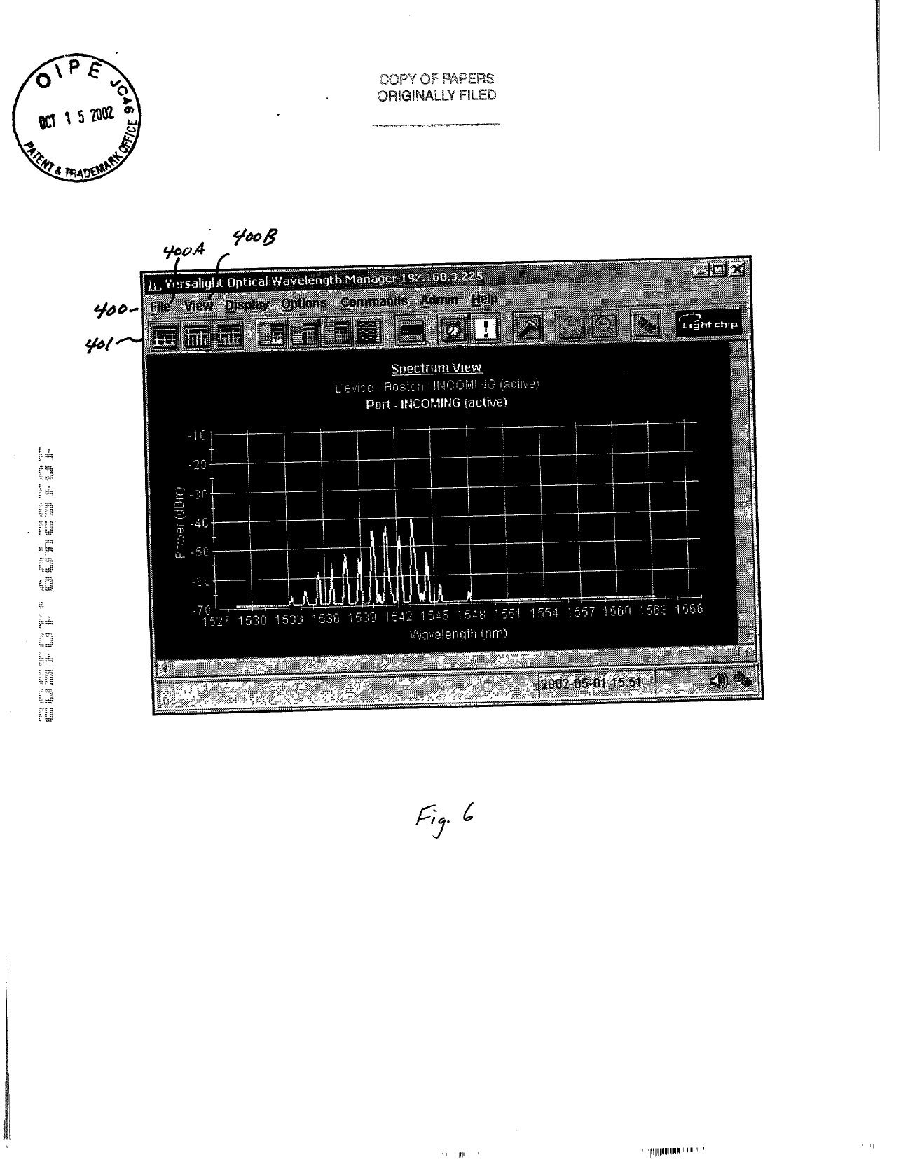

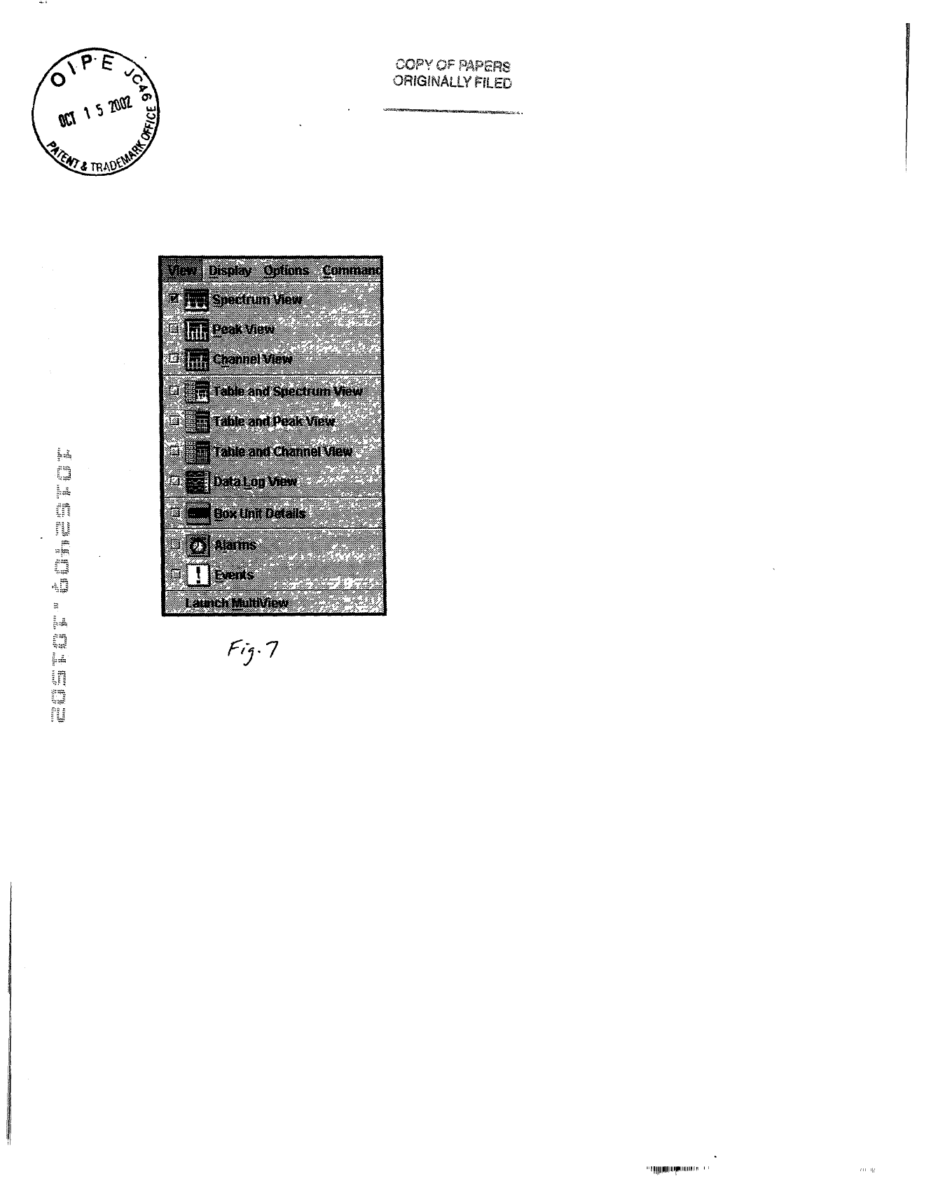

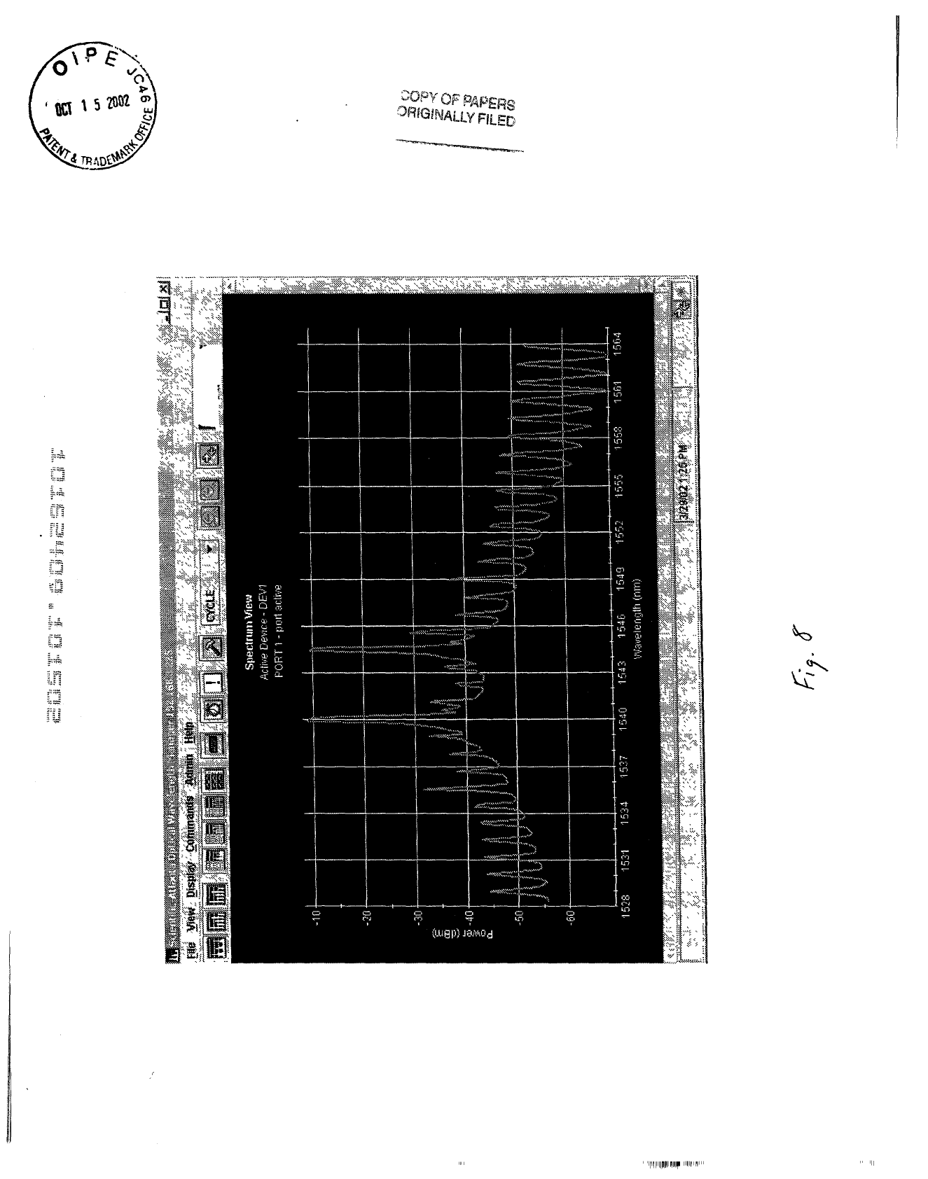

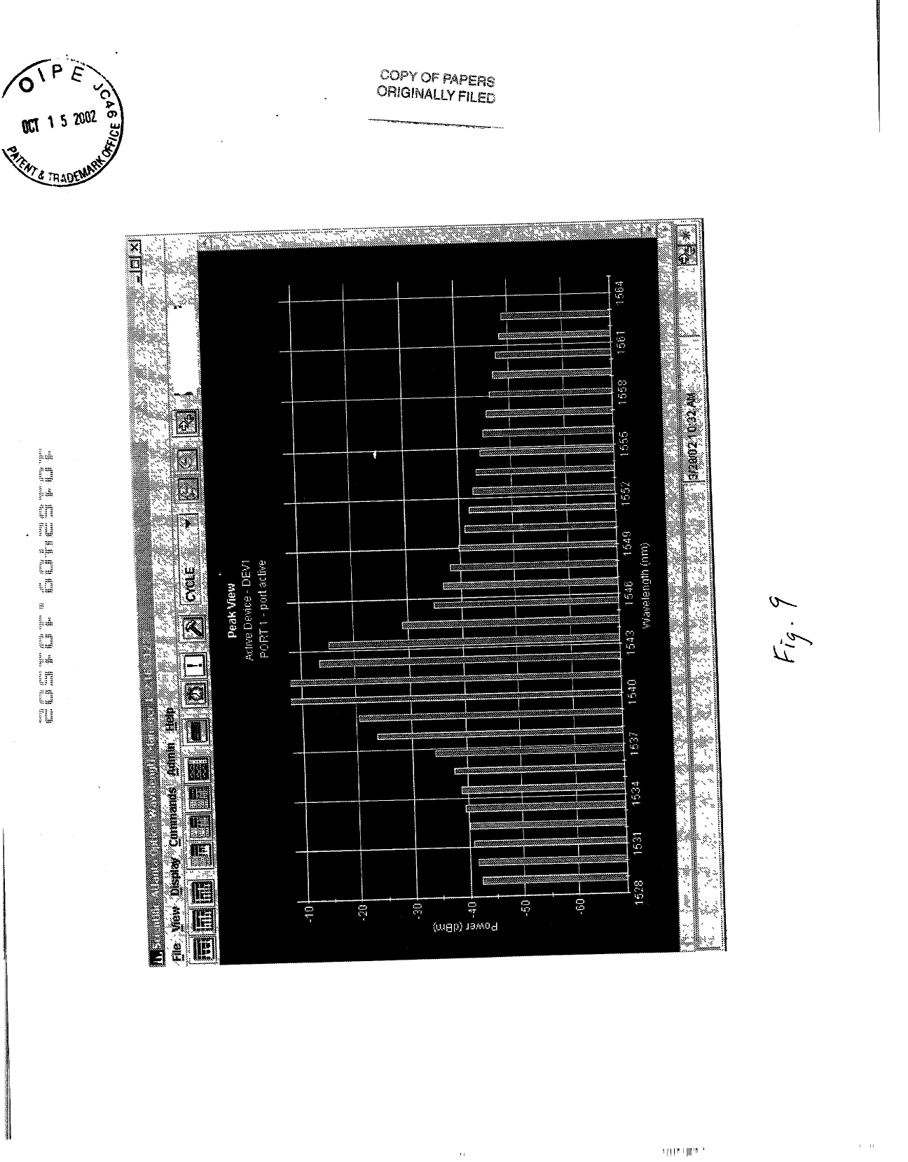

Another pull-down menu 400B, a “view” menu, may provide commands to allow a user to select any of a number of views of the data collected by spectrometers 140, as shown in FIG. 7. For instance, a “spectrum” view may be selected in which a point-by-point plot of the optical power spectrum appearing on a fiber optic line 135 may be presented on device 245. As shown in FIG. 8, the spectrum view may be a polyline plotted from power measurements made at substantially regular intervals across the measurement range of OPM 125. In addition, the particular fiber optic line 135/port 136 selected is displayed. In the event the power spectrum measurement is determined by OPM 125 to be saturated, the spectrum graph is displayed in a first color, such as red, whereas the spectrum graph is displayed in a second color, such as yellow, in the event the power spectrum measured is unsaturated.

A second view that may be selected for display on device 245 using the view menu 400B may be a “peak” view. As shown in FIG. 9, the peak view may display, in bar graph form, the peak power of each channel of the WDM signal appearing on the selected fiber optic line 135. In addition, the measured peak power level and corresponding wavelength and OSNR may be presented in text form by holding the icon (operable by a mouse or similar device) over a desired bar and activating a button (on the mouse or keyboard/keypad key, for example).

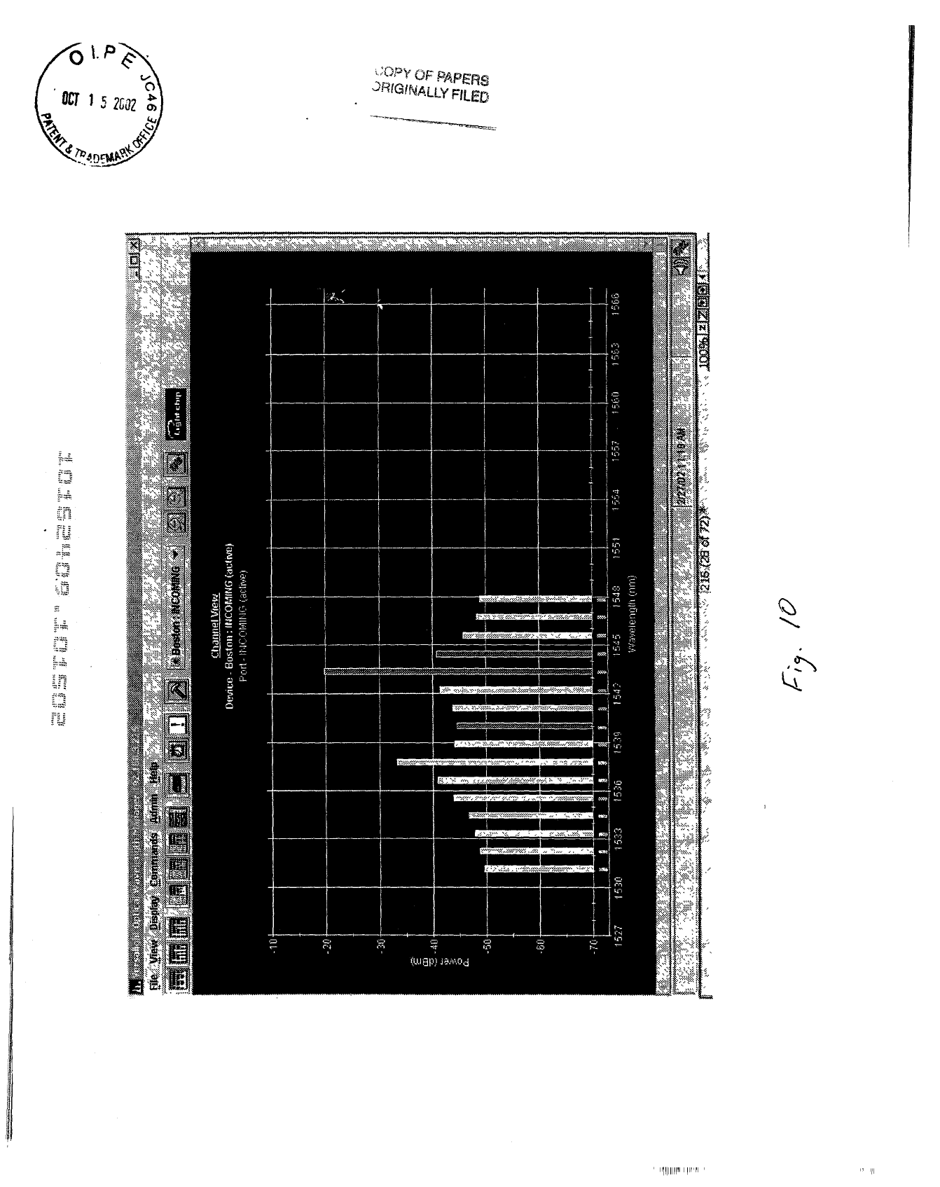

Another view that may be selected for display on monitor device 245 using the view menu 400B may be a “channel” view. As shown in FIG. 10, the channel view may display, in bar graph form, each channel defined on the WDM signal appearing on the selected fiber optic line 135. For each channel, the measured power level and the alarm state may be displayed. In particular, the channel data may be displayed in one color, such as green. In the event a channel is in an alarm state, the channel information is displayed in a color corresponding to the most severe alarm. For instance, if a critical alarm is detected for a channel, the channel data may be displayed in a first alarm color, such as red. If a major alarm is detected, the channel data may be displayed in a second alarm color, such as yellow. If a minor alarm for a channel is detected, the channel data may be displayed in a third alarm color, such as blue. Similar to the peak view, the measured peak power level, wavelength and OSNR may be presented in text form, such as in a status window appearing below the bar graph, by holding the icon (operable by a mouse or similar device) over a desired channel display and activating a button (on the mouse or keyboard/keypad key, for example). Moreover, the defined center wavelength WL for each channel may be displayed, as shown in the lower portion of FIG. 10.

Further, individual channel information may be displayed on a device 245 using the channel view. For example, by holding the icon over a particular channel display and activating a button (on the mouse, for example), a detailed view of the selected channel may be shown. The individual channel view may display information of the selected channel in both graphical and tabular form substantially simultaneously. As shown in FIG. 11, a graph of measured power of the selected channel may be displayed. Alarm settings may be shown in the graph by displaying each alarm setting as vertical line segments (for wavelength related alarms) and horizontal line segments (for power and OSNR related alarms). Each type of alarm setting may be displayed in a different color. The alarm settings may be selectively displayed on the graph through use of selection/deselection buttons.

With respect to the tabular form, there may be displayed, in a table, the entire channel definitions (wavelength, power, OSNR, signal peak, and alarm settings) and corresponding measured values for a given channel. In order to be able to view each channel of the selected power spectrum, the display on monitor 245 may include “previous” and “next” buttons 1100. Activation of the previous or next buttons 1100 will cause the view of the next defined channel in the optical power spectrum to be displayed.

Another view that may be selected for display on device 245 using the view menu 400 may be a “channel data log” view. With reference to FIG. 12, the channel data log view may display signal characteristics of a selected channel with respect to time. Histograms of measured power, wavelength and OSNR may be shown as well. The length of the time period over which the measured signal characteristics are displayed may be fixed at a predetermined time period or varied by a user. The signal characteristic measured for a particular time may be displayed in a pop-up window by placing the screen icon over a point in a given signal measurement graph and manipulating a key on a keypad or button on a mouse. The amount of time between measurements may be predetermined or selected by a user. The time between measurements may be on the order of one or more minutes, days or weeks. Sets of measurements may be downloaded to permanent storage devices, such as floppy disks.

A “table and spectrum” view may be selected for display on device 245 using the view menu 400B. As shown in FIG. 13, the table and spectrum view may display information of the selected optical power spectrum in both graphic and tabular form. The graphic form is similar to the graphic form of the spectrum view. The tabular form may identify the measured peak, wavelength and OSNR for each channel in the optical power spectrum. If a button on a mouse (or other device) is activated while the icon is in the graph, the closest peak to the icon is highlighted in the table.

Another view that may be selected for display on monitor 245 using the view menu 400B may be a “table and peak” view. The table and peak view displays a table of the peaks measured as well as a bar graph thereof. Power, wavelength and OSNR values may also be displayed in the table. If a button on a mouse (or other device) is activated while the icon is in the graph, the closest peak to the icon may be highlighted in the table.

A “table and channel” view may be selected for display on monitor device 245 using the view menu 400B. As shown in FIG. 14, the table and channel view may display information of the selected optical power spectrum in both graphic and tabular form. The graphic form may be a bar graph. The tabular form may identify the measured peak, wavelength and OSNR for each channel in the optical power spectrum. If a button on a mouse (or other device) is activated while the icon is in the graph, the closest peak to the icon is highlighted in the table.

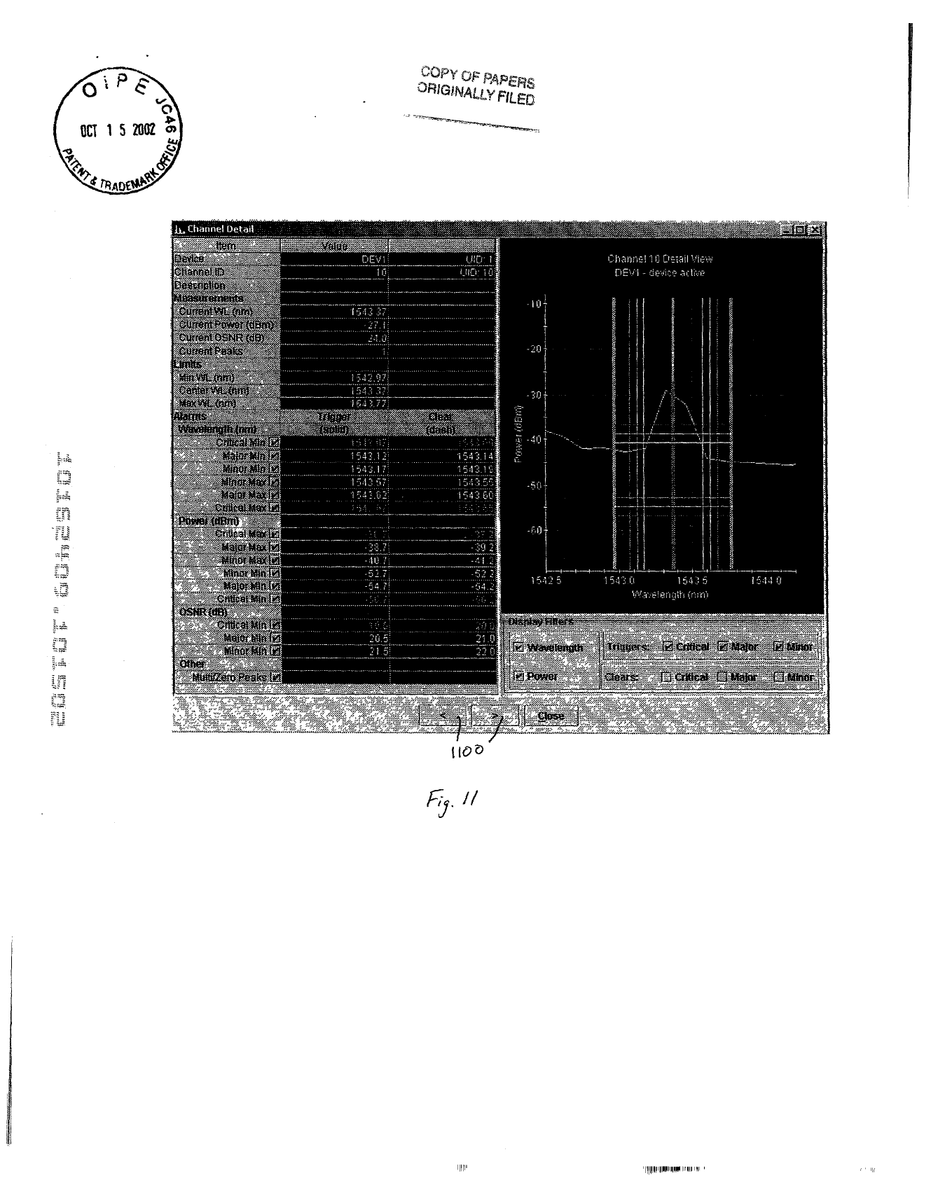

A “multi-view” view may be selected for display on monitor device 245 using the view menu 400B. Spectrum, peak and channel views may be simultaneously displayed for a plurality of the selected WDM signal measured. FIG. 15 is an exemplary display of the multi-view view. The particular views that are displayed as well as the size and arrangement thereof may be selected by commands available in GUI 265.

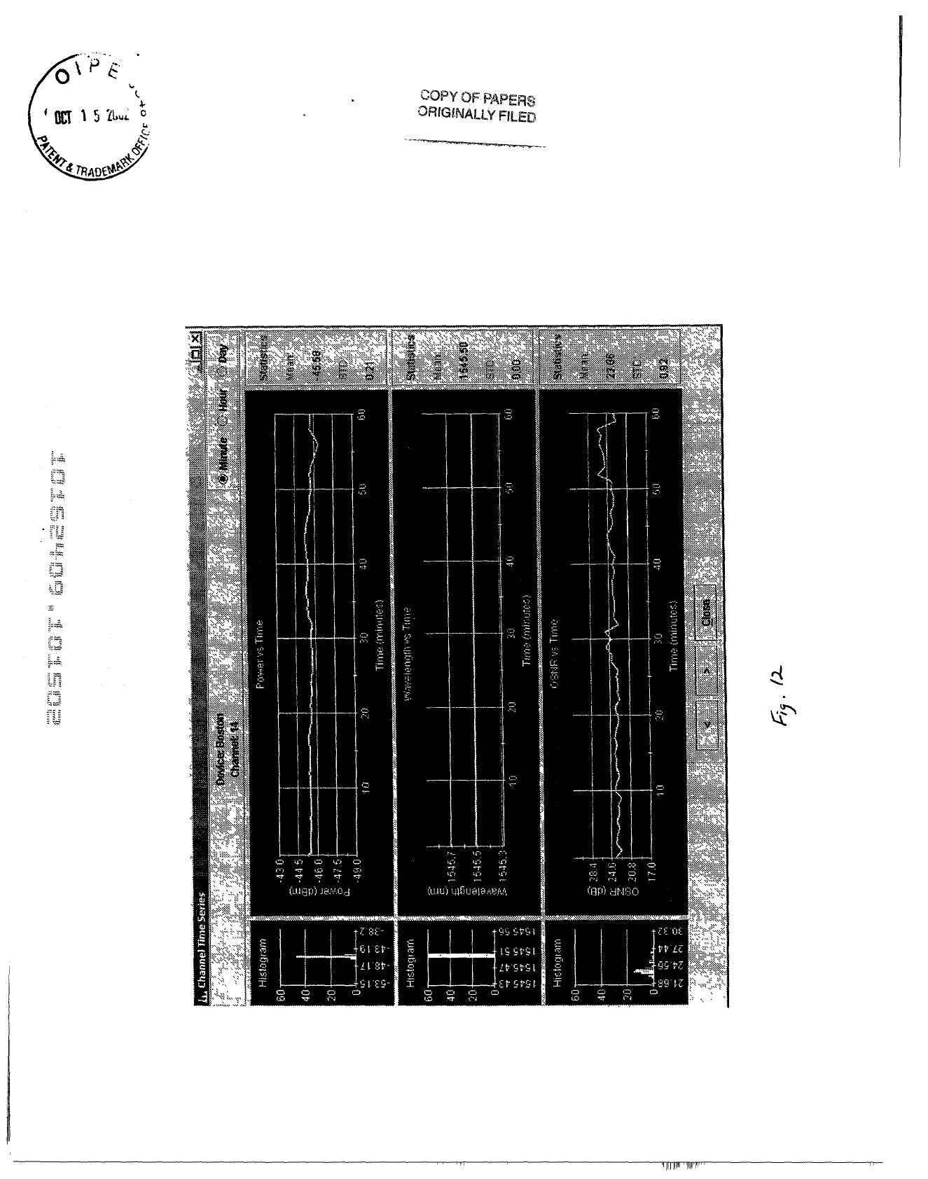

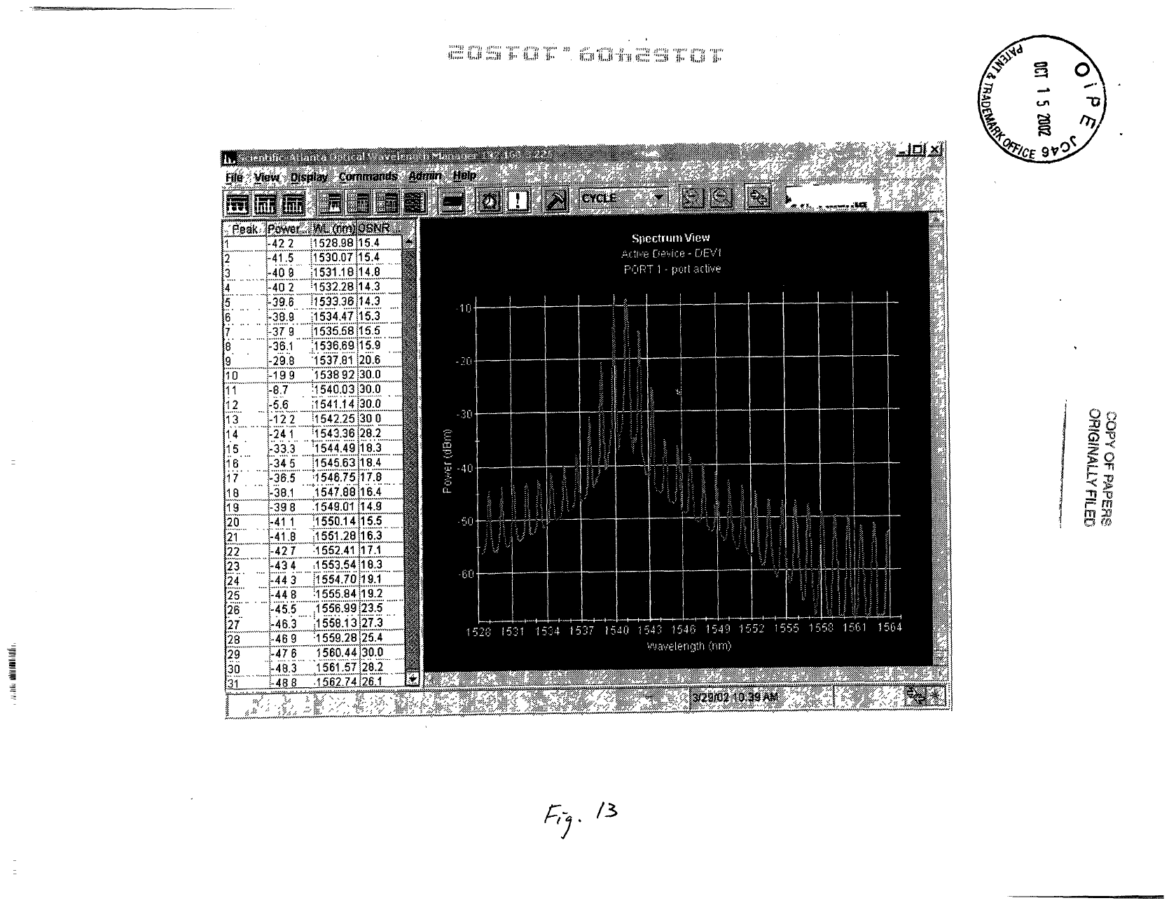

The GUI 265 may allow for the average power level of the channels to be selectively displayed in a graph of measured channel power level. FIG. 16 illustrates a bar graph of a optical power spectrum including the average measured power level.

In addition to selecting the views described above by employment of a pull-down menu 400, a toolbar 401 (FIG. 6) may be displayed on a device 245 having thereon a distinct icon for each selectable view.

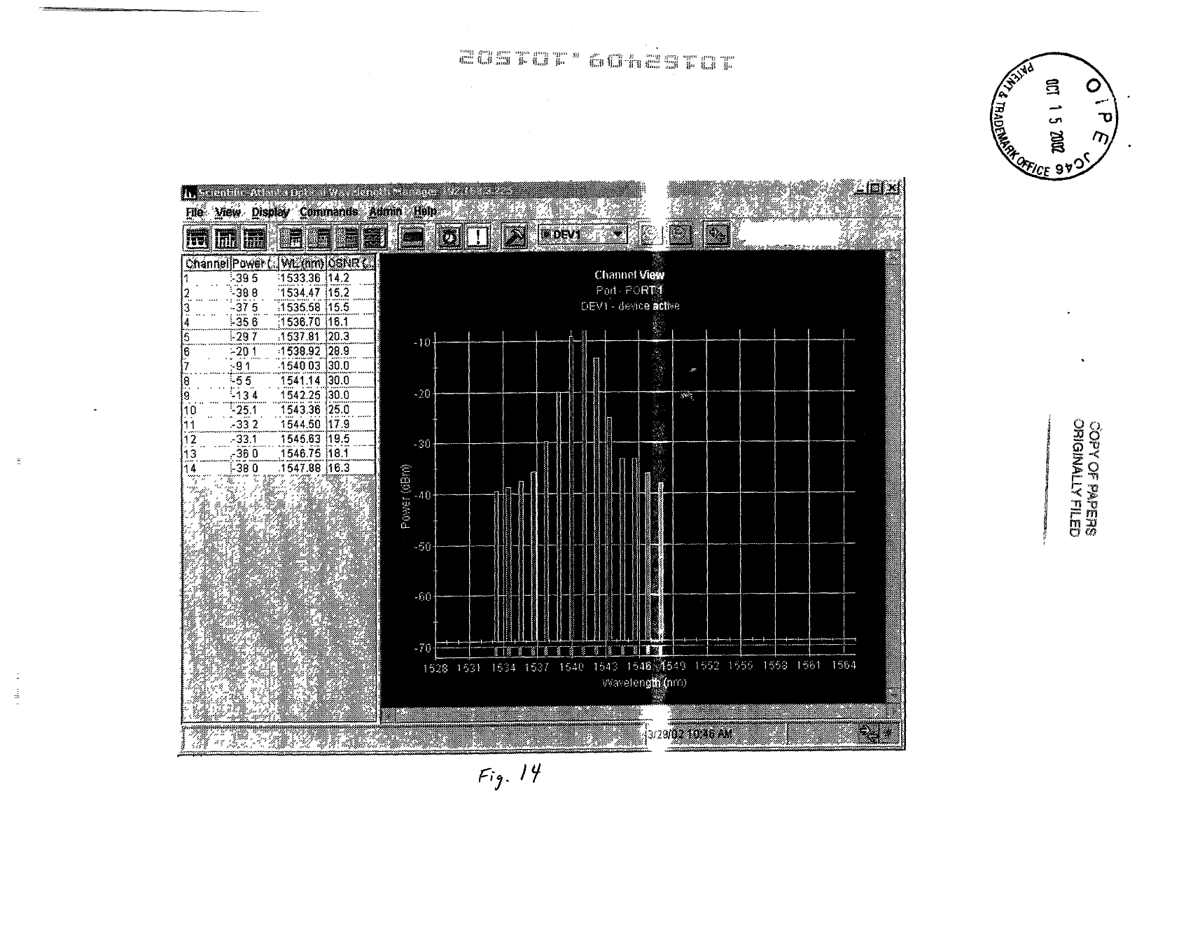

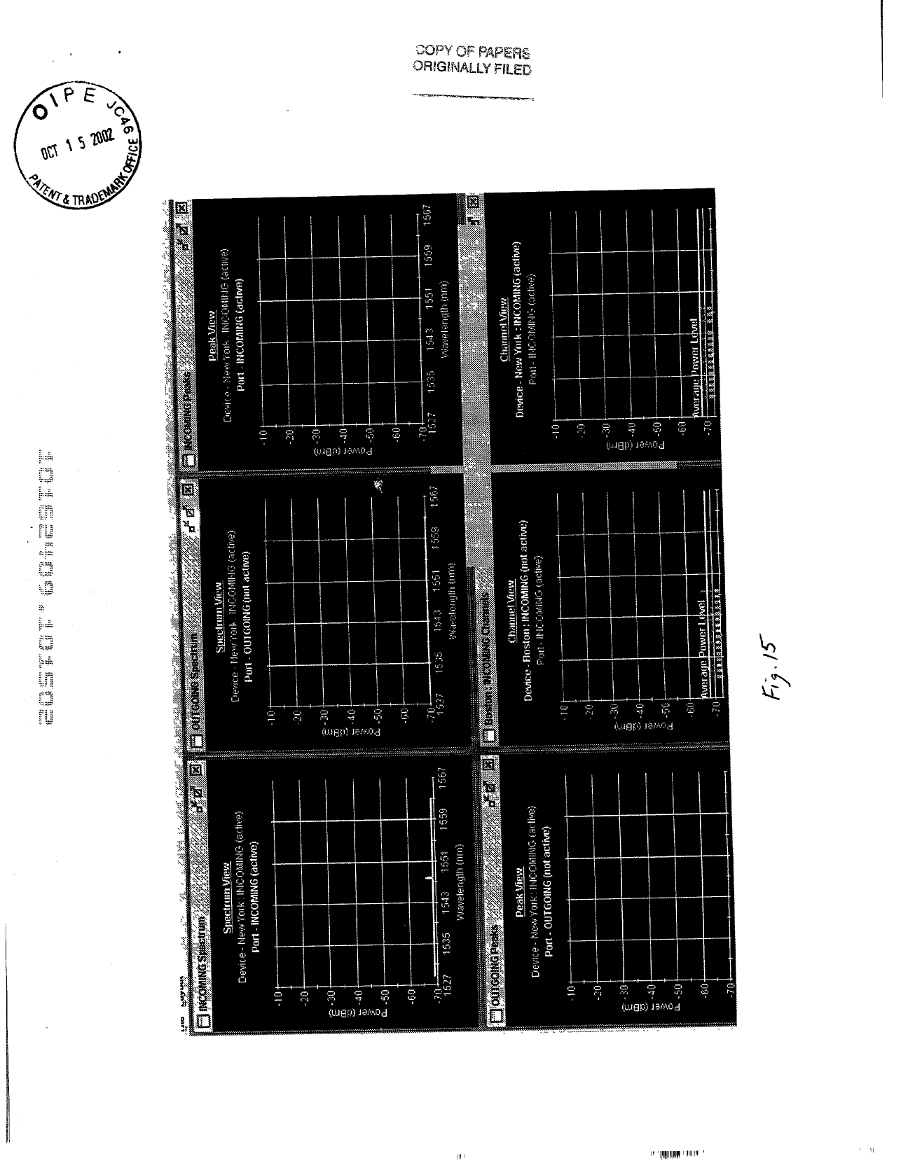

Upon activation of a command from the view menu 400 or a toolbar icon, the alarms that have been violated may be viewed. With respect to FIG. 17, the alarms may be viewed for the channels in the WDM signal appearing on the selected fiber optic line 135. The information displayed for each alarm may include the severity level, description of the alarm violation, record of the violation, date of the violation, port and channel number. By activating a button, such as on a mouse, while the icon is placed over the description field of an alarm, a record ID and/or time stamp as well as a detailed description of the alarm may be displayed. By activating the button while the icon is placed over the channel number, the individual channel view (FIG. 11) may be displayed. The alarm information may be periodically updated. However, a pause button appearing in the alarm view may suspend the periodic update. The alarms displayed may be color coded to indicate alarm type (minor, major, critical).

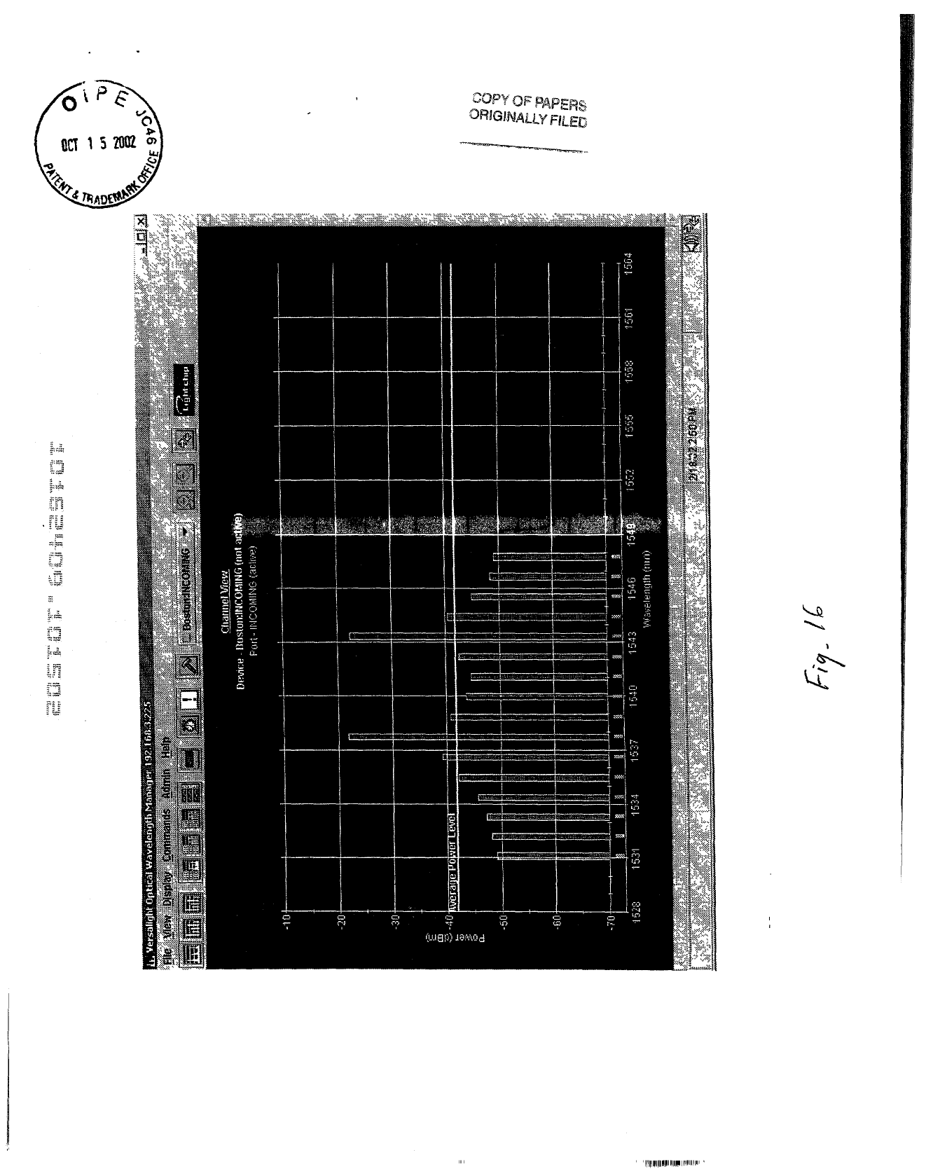

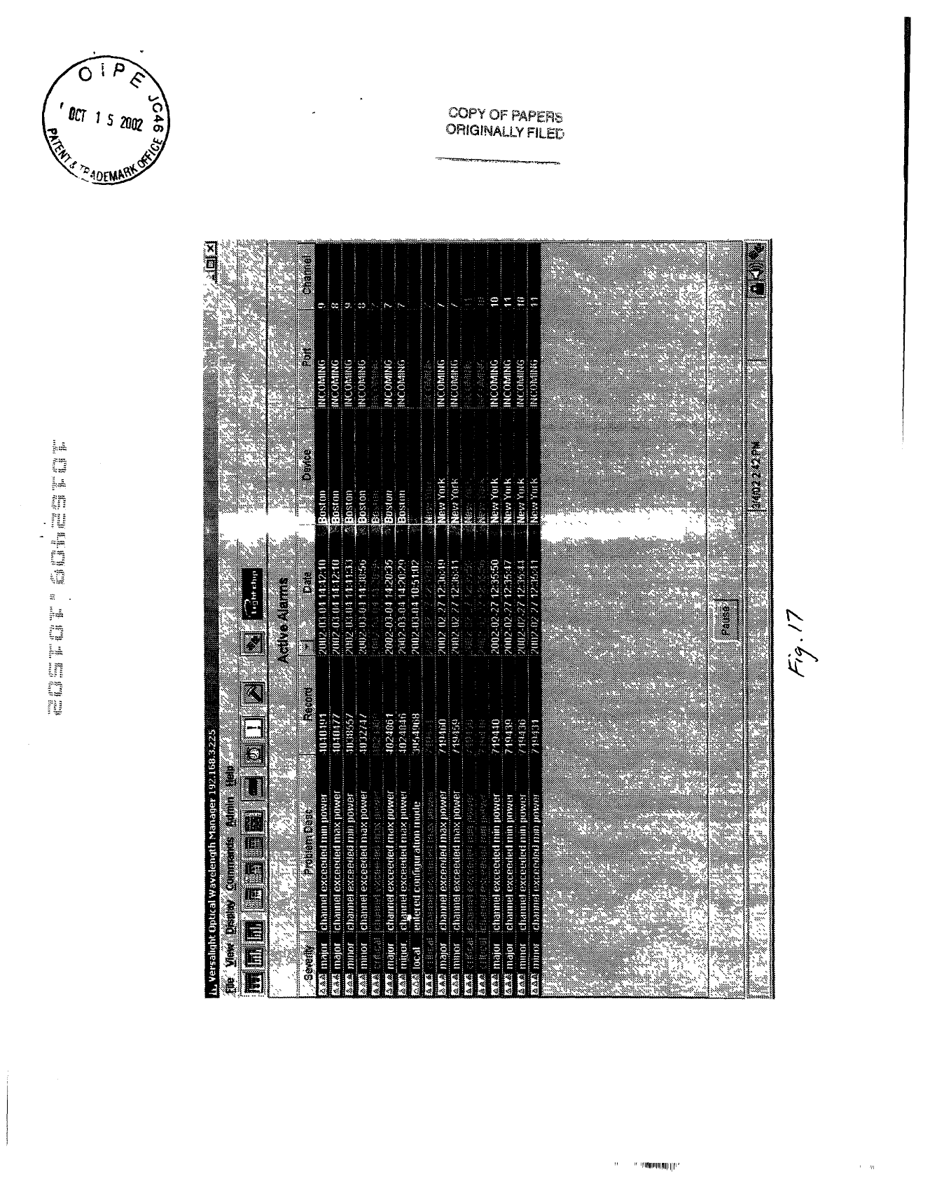

Relatedly, the GUI 265 may allow for the events to be viewed in response to activation of a command from the view menu 400 or a toolbar icon. With respect to FIG. 18, the events may be viewed for the channels in the WDM signal appearing on the selected fiber optic line 135. The information for each event may include the severity level (if the event is an alarm violation), description, record, date, port and channel number may be displayed. By activating a button, such as on a mouse, while the icon is placed over the description field of an event, a record ID and/or time stamp as well as a detailed description of the event may be displayed. By activating the button while the icon is placed over the channel number, the individual channel view may be displayed. The event information may be periodically updated. However, a pause button appearing in the event view may suspend the periodic update. The alarms displayed may be color coded to indicate event type.

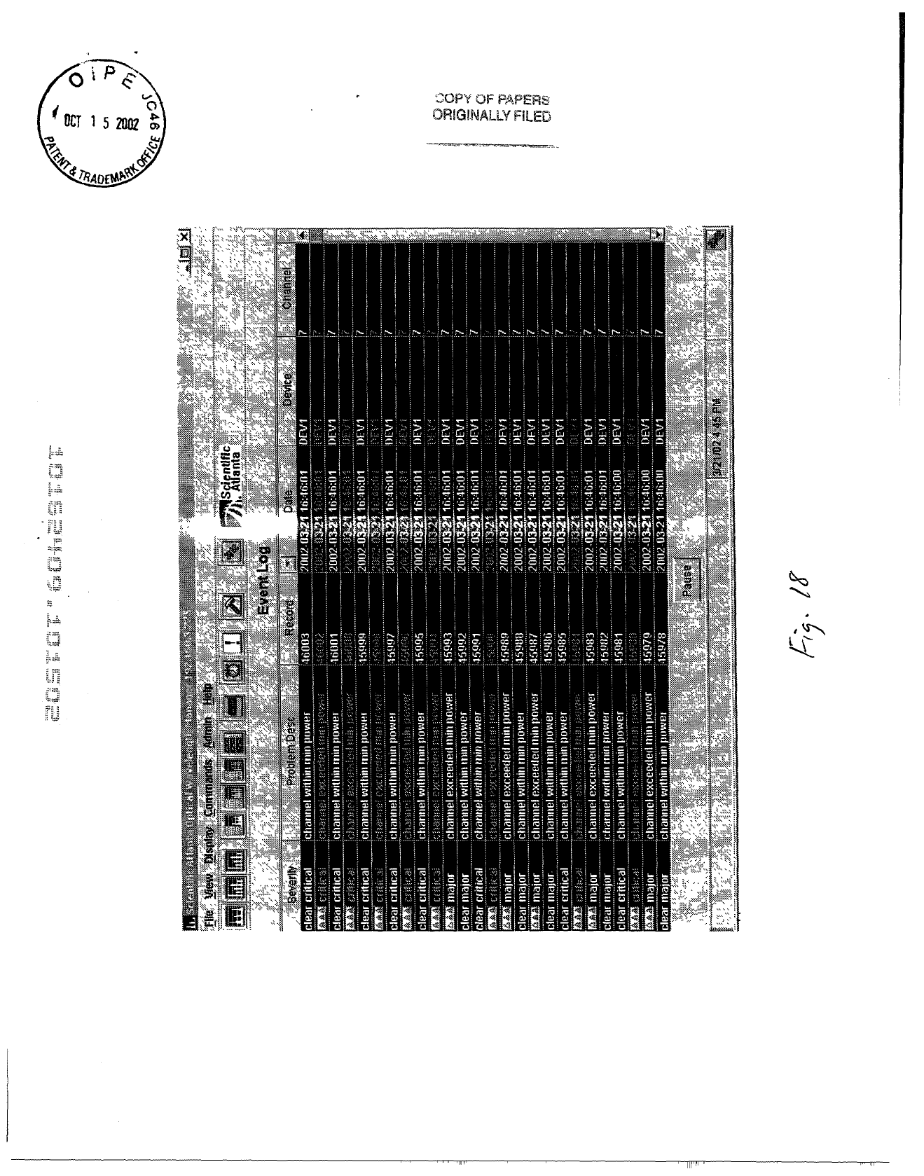

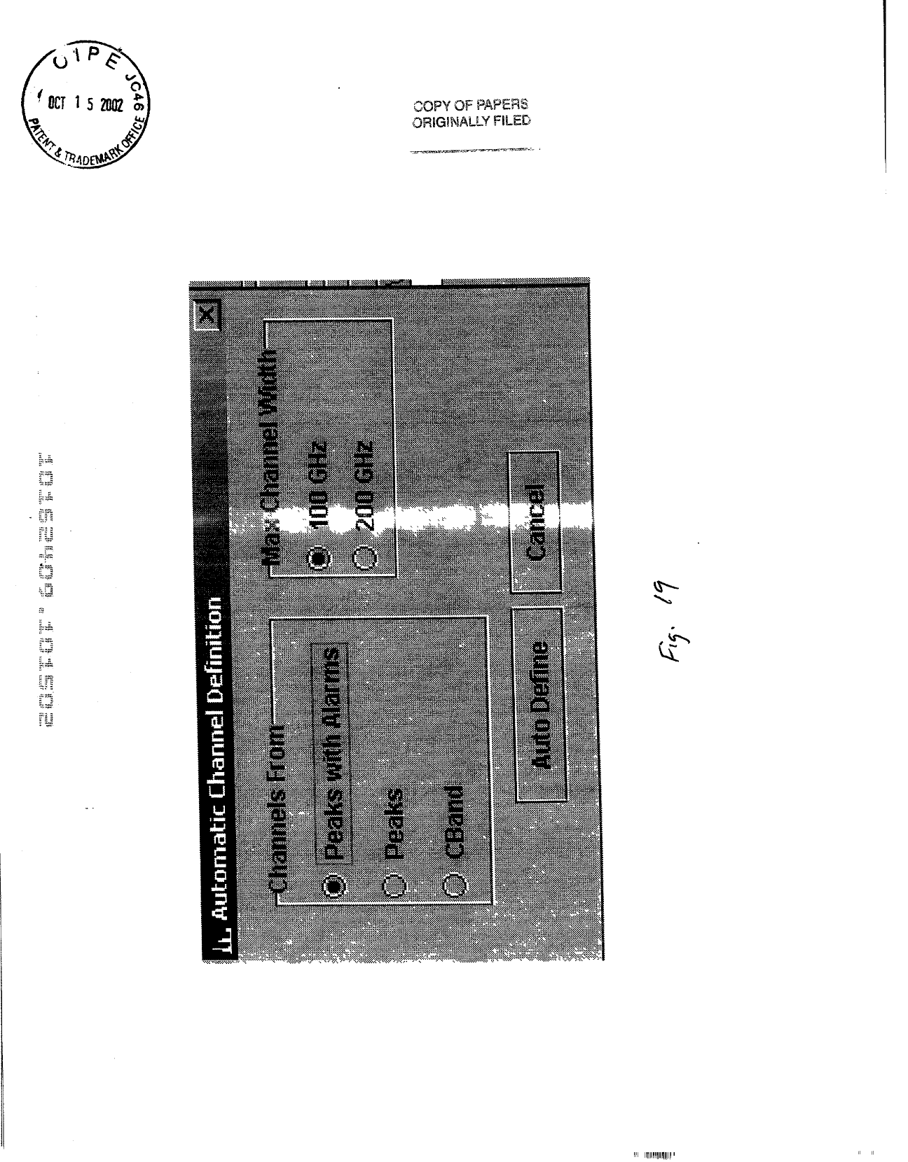

The GUI 265 may allow for the configuration of WDM input signals to be relatively simple. A displayed device “new” button may be activated to automatically define channels associated with a fiber optic line 135/port 136. In response, a channel definition window may be displayed (FIG. 19) that allows for automatic channel definition through use of a number of channel-related options. For instance, a “peaks with alarms” option may be activated to automatically define the channels and corresponding alarms. In particular, the current state of the OPM 125 is captured, including the current port 136, the current device, and the state of optical switch 170. The OPM 125 may switch to the selected port 136 and obtain the measured peak values associated therewith. For each signal peak measured, a channel is automatically defined. For each peak signal captured, power and OSNR values may be taken with their corresponding channel definition. Alarms may be automatically defined for each channel.

A “peak” option, when activated, may capture the current state of OPM 125, including the current port 136, selected device and the state of optical switch 170. The OPM 125 may switch to the selected port 136 and obtain the measured peak values associated therewith. For each signal peak measured, a channel is automatically defined. A “Cband” option may obtain the first 40 channels in the C-band that meet the minimum requirements for an OPM channel. A window may be selectively displayed for enabling/disabling the alarms.

Channels may be manually defined. Activation of a “new channel” command in a menu 400 displays a window in which center, minimum and maximum wavelength values may be entered as well as a description of the channel in a description field. After a channel has been defined, the channels are again sorted by center wavelength, and the channel numbers updated. Channel alarms for the newly defined channel may then be defined using the channel view described above.

Software program 240 may also include instructions which, when executed by processor 230, provides a command line interface to a user at a device 245. The command line interface may allow a user to configure OPM 125, as described above.

OPM 125 may include additional features that may be available to a user using GUI 265 or the command line interface. OPM 125 may be able to calculate and provide to a user (upon request) a calculation of the total power level from the channels from which power levels were measured. OPM 125 may further calculate and provide to the user a composite power level. The composite power level is the total power level in the optical power spectrum, and includes power from noise and undefined channels in the spectrum.

Another available feature of OPM 125 may be providing to a user (upon request) a presentation of one or more measured signal channel characteristics relative to a set of benchmark or reference measurements of the signal channel characteristics. In particular, OPM 125 may provide to a user, via GUI 265 or the command line interface, a “set benchmark” command which, when actuated by the user, assigns as the benchmark measurements a previously recorded set of measurements of the one or more signal characteristics (power, wavelength, OSNR). The user may, for example, identify the particular set of previously recorded measurements by providing a time at which the measurements were made. Another command, a “compare benchmark” command, may be executed by the user so that subsequent measurements of the signal characteristics are presented with reference to the identified benchmark measurements. Upon activation of the compare benchmark command, OPM 265 may compare current signal characteristic measurements with the benchmark measurements and present the comparison results to the user. The comparison results may be presented as a difference between the current measurements and the benchmark measurements, or as the arithmetic quotient of the current measurements to the benchmark measurements.

Another feature provided by OPM 125 may be displaying in addition to current measurements of signal characteristics (power, wavelength and OSNR), indications of the high and low values for each signal characteristic over a recently completed period of time. The length of the period of time may be predetermined or selected by the user. In use, for each period of time that has elapsed, processing unit 150 determines the low value and the high value for each signal characteristic and generate signals for display on device(s) 245 indicative of the low and high value determinations.

OPM 125 may also include a feature that allows for signal measurements to be displayed with respect to the time zone in which the corresponding user is located. For example, the user may be capable of identifying the particular time zone of the user. Subsequent measurements of signal characteristics recorded and/or provided to devices 245 for display may be based upon the user-supplied time zone.

In order to synchronize OPM 125 with devices 245 and other devices appearing in the optical communications network in which OPM 125 is disposed, OPM 125 may include a client that complies with the Simple Network Time Protocol (SNTP). SNTP client functionality may be provided by processing unit 230 using software instructions in software program 240.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for monitoring wavelength division multiplexed signals, comprising:
at least one port for receiving a wavelength division multiplexed signal;
a spectrometer having an input coupled to the at least one port and an output;
a processing unit coupled to the output of the spectrometer, for receiving and processing data from the spectrometer corresponding to channels of the wavelength division multiplexed signal; and
memory, coupled to the processing unit, having stored therein at least one software program including instructions which, when executed by the processing unit, cause the processing unit to generate signals for displaying measured signal characteristics of one or more channels of the wavelength division multiplexed signal on a monitor in graphic and tabular form simultaneously.

2. The apparatus of claim 1, wherein the signal characteristics of the one or more channels of the wavelength division multiplexed signal are capable of being displayed on the monitor for one channel at a time.

3. The apparatus of claim 2, wherein a signal characteristic of channels of the wavelength division multiplexed signal displayed in graphic form is optical power.

4. The apparatus of claim 1, wherein a signal characteristic of the wavelength division multiplexed signal displayed in tabular form is OSNR.

5. The apparatus of claim 1, wherein a signal characteristic of the wavelength division multiplexed signal displayed in tabular form is wavelength.

6. The apparatus of claim 1, wherein a signal characteristic of the one or more channels of the wavelength division multiplexed signal displayed in graphic form is center wavelength.

7. The apparatus of claim 1, wherein a signal characteristic of the wavelength division multiplexed signal displayed in tabular form is optical power.

8. The apparatus of claim 1, wherein the at least one software program includes a user interface including instructions which, when executed by the processing unit, allow for defining channels of the wavelength division multiplexed signal to be monitored.

9. The apparatus of claim 8, wherein defining channels of the wavelength division multiplexed signal comprises defining minimum, center and maximum wavelength values for each channel being defined.

10. The apparatus of claim 8, wherein the user interface is a graphical user interface.

11. The apparatus of claim 1, wherein the at least one software program includes a user interface including instructions which, when executed by the processing unit, allow for defining of monitor parameters for monitoring the wavelength division multiplexed signal.

12. The apparatus of claim 11, wherein the monitor parameters define a window of values for at least one signal characteristic of a channel of the wavelength division multiplexed signal, and the at least one software program includes instructions which, when executed by the processing unit, cause the processing unit to generate a signal indicating the at least one signal characteristic of the channel is not within the window of values.

13. The apparatus of claim 1, further comprising a plurality of ports for receiving a plurality of wavelength division multiplexed signals and an optical switch coupled between the ports and the input of the spectrometer, wherein the processing unit generates signals for displaying measured signal characteristics of one or more channels of wavelength division multiplexed signals appearing on the ports of the apparatus.

14. The apparatus of claim 1, wherein the signals generated for displaying measured signal characteristics of the one or more channels include a comparison of the measured signal characteristics of the one or more channels relative to a set of predetermined benchmark measurements of the signal characteristics.

15. The apparatus of claim 1, wherein at least one of the measured signal characteristics of the one or more channels displayed is total power of the channels of the wavelength division multiplexed signal.

16. The apparatus of claim 1, wherein at least one of the measured signal characteristics of the one or more channels displayed is composite power of the power spectrum of the wavelength division multiplexed signal.

17. The apparatus of claim 1, wherein the signals generated for displaying the measured signal characteristics of the one or more channels include an indication of high and low measurements for at least one of the measured signal characteristics relative to a predetermined period of time.

18. An apparatus for monitoring wavelength division multiplexed signals, comprising:
at least one port for receiving a wavelength division multiplexed signal;
a spectrometer having an input coupled to the at least one port and an output;
a processing unit coupled to the output of the spectrometer, for receiving and processing data from the spectrometer corresponding to channels of the wavelength division multiplexed signal; and
memory, coupled to the processing unit, having stored therein at least one software program including instructions which, when executed by the processing unit, cause the processing unit to generate signals for displaying measured signal characteristics of one or more channels of the wavelength division multiplexed signal on a monitor, the at least one software program further including instructions which, when executed by the processing unit, cause the processing unit to allow defining of a range of values of at least one of the measured signal characteristics and to indicate when the at least one of the measured signal characteristics of the one or more channels falls outside of the range of values.

19. The apparatus of claim 18, wherein the range of values of the at least one of the measured signal characteristics is automatically defined by the apparatus.

20. The apparatus of claim 18, wherein the range of values of the at least one of the measured signal characteristics is manually defined.

21. The apparatus of claim 18, wherein the at least one of the measured signal characteristics is channel wavelength.

22. The apparatus of claim 18, wherein the at least one of the measured signal characteristics is power.

23. The apparatus of claim 18, wherein the at least one of the measured signal characteristics is OSNR.

24. The apparatus of claim 18, wherein the instructions of the at least one software program, when executed by the processing unit, cause the processing unit to allow defining of a plurality of ranges of values of the at least one of the measured signal characteristics and to indicate when the at least one of the measured signal characteristics of the one or more channels falls outside any of the ranges of values.

25. The apparatus of claim 24, wherein a first range of the ranges of values is a subset of a second range of the ranges of values.

26. The apparatus of claim 25, wherein a second range of the ranges of values is a subset of a third range of values.

27. The apparatus of claim 18, wherein the signals generated for displaying measured signal characteristics of the one or more channels of the wavelength division multiplexed signal on a monitor further display the defined range of values.

28. The apparatus of claim 18, wherein the signals generated for displaying measured signal characteristics of the one or more channels of the wavelength division multiplexed signal on a monitor graphically displays the measured signal characteristics and the defined range of values in a single graph.

29. The apparatus of claim 18, wherein the processing unit generates the signals for displaying the at least one of the measured signal characteristics in a color coded manner in which the at least one of the measured signal characteristics is displayed in a first color when falling within the defined range of values and in a second color when falling outside the defined range of values.

30. A device for monitoring wavelength division multiplexed signals, comprising:
at least one port for receiving a wavelength division multiplexed signal;
a spectrometer having an input coupled to the at least one port and an output;
a processing unit coupled to the output of the spectrometer, for receiving and processing data from the spectrometer corresponding to channels of the wavelength division multiplexed signal; and
memory, coupled to the processing unit, having stored therein at least one software program including instructions which, when executed by the processing unit, provides a graphical user interface for defining channels of the wavelength division multiplexed signals to be measured, the user interface including commands to define alarm levels for detecting operating conditions of the wavelength division multiplexed signal that fall outside of desired operating levels.

31. A method of monitoring optical signals, comprising:
defining channel characteristics for a wavelength division multiplexed optical signal to be monitored;
defining a range of values of at least one signal characteristic of a channel of the wavelength division multiplexed optical signal to be monitored;
receiving the wavelength division multiplexed optical signal;
measuring the at least one signal characteristic for each channel of the wavelength division multiplexed optical signal received;
determining whether the at least one signal characteristic measured falls within the range of values; and
indicating the results of the determination.

32. The method of claim 31, wherein the step of indicating comprises graphically indicating the results of the determination.

33. A computer product embodying program instructions for execution by a device that monitors wavelength division multiplexed signals, the computer product including program instructions for:
generating signals for displaying measured signal characteristics of one or more channels of the wavelength division multiplexed signal on a monitor in graphic and tabular forms simultaneously.

34. The computer product of claim 33, wherein the signal characteristics of the one or more channels of the wavelength division multiplexed signal are capable of being displayed on the monitor for one channel at a time.

35. The computer product of claim 33, wherein a signal characteristic of channels of the wavelength division multiplexed signal displayed in graphic form is optical power.

36. The computer product of claim 33, wherein a signal characteristic of the wavelength division multiplexed signal displayed in tabular form is OSNR.

37. The computer product of claim 33, wherein a signal characteristic of the wavelength division multiplexed signal displayed in tabular form is wavelength.

38. The computer product of claim 33, wherein a signal characteristic of the one or more channels of the wavelength division multiplexed signal displayed in graphic form is center wavelength.

39. The computer product of claim 33, wherein a signal characteristic of the wavelength division multiplexed signal displayed in tabular form is optical power.

40. The computer product of claim 33, wherein the computer product includes instructions for providing a user interface including instructions which, when executed by the device, allow for defining channels of the wavelength division multiplexed signal to be monitored.

41. The computer product of claim 40, wherein defining channels of the wavelength division multiplexed signal comprises defining minimum, center and maximum wavelength values for each channel being defined.

42. The computer product of claim 40, wherein the user interface is a graphical user interface.

43. The computer product of claim 33, wherein the computer product includes instructions for providing a user interface including instructions which, when executed by the processing unit, allow for defining of monitor parameters for monitoring the wavelength division multiplexed signal.

44. The computer product of claim 33, wherein the signals generated for displaying measured signal characteristics of the one or more channels include a comparison of the measured signal characteristics of the one or more channels relative to a set of predetermined benchmark measurements of the signal characteristics.

45. The computer product of claim 33, wherein at least one of the measured signal characteristics of the one or more channels displayed is total power of the channels of the wavelength division multiplexed signal.

46. The computer product of claim 33, wherein at least one of the measured signal characteristics of the one or more channels displayed is composite power of the power spectrum of the wavelength division multiplexed signal.

47. The computer product of claim 33, wherein the signals generated for displaying the measured signal characteristics of the one or more channels include an indication of high and low measurements for at least one of the measured signal characteristics relative to a predetermined period of time.

48. A computer product embodying program instructions for execution by a device that monitors wavelength division multiplexed signals, the computer product including program instructions for:
defining channel characteristics for a wavelength division multiplexed optical signal to be monitored;
defining a range of values of at least one signal characteristic of a channel of the wavelength division multiplexed optical signal to be monitored;
receiving the wavelength division multiplexed optical signal;
measuring the at least one signal characteristic for each channel of the wavelength division multiplexed optical signal received;
determining whether the at least one signal characteristic measured falls within the range of values; and
indicating the results of the determination.

49. The computer product of claim 48, wherein the indicating comprises graphically indicating the results of the determination.

50. The computer product of claim 48, wherein the range of values of the at least one of the measured signals characteristics is automatically defined.

51. The computer product of claim 48, wherein the range of values of the at least one of the measured signals characteristics is manually defined.

52. The computer product of claim 48, wherein the at least one of the measured signal characteristics is channel wavelength.

53. The computer product of claim 48, wherein the at least one of the measured signal characteristics is channel power.

54. The computer product of claim 48, wherein the at least one of the measured signal characteristics is channel OSNR.

55. The computer product of claim 48, wherein the instructions allow for defining of a plurality of ranges of values of the at least one of the measured signal characteristics and indicating to a user when the at least one of the measured signal characteristics of the one or more channels falls outside any of the ranges of values.
